(19) United States
(12) Patent Application Publication
(10) Pub. No.: US 2015/0134343 A1
(43) Pub. Date: May 14, 2015

(54) Interactive Communications System for the Coordination and Management of patient-Centered Health Care Services

(71) Applicants: Andrew Michael Kluger, San Rafael, CA (US); Stanley Ian Drew, Encino, CA (US); Miguel Alborg Dominguez, Valencia (ES); Miguel Alborg Farinos, Valencia (ES)

(72) Inventors: Andrew Michael Kluger, San Rafael, CA (US); Stanley Ian Drew, Encino, CA (US); Miguel Alborg Dominguez, Valencia (ES); Miguel Alborg Farinos, Valencia (ES)

(21) Appl. No.: 13/261,963

(22) PCT Filed: May 15, 2013
(86) PCT No.: PCT/US13/00132

§ 371 Date: Sep. 30, 2014

Related U.S. Application Data
(60) Provisional application No. 61/688,524, filed on May 16, 2012.
(60) Provisional application No. 61/743,940, filed on Sep. 13, 2012.

(51) Int. Cl. G06F 3/0484; H04L 12/58; G06F 3/0488

(52) U.S. Cl. CPC G06F 3/04842; G06F 3/04886; H04L 51/24; G06Q 50/22
USPC 705/2

(57) ABSTRACT

An interactive computer managed communications system is described whereby health care providers to a patient-subscriber are selected for inclusion into an interconnected health care provider network of a patient-sbuscriber, whereby the system can deliver and receive information, alerts, reports, reminders and other messaging simultaneously in a coordinated and seamless manner to all parties within the network without the need to use alternative communications platforms or query third party data bases. Thus, coordinated decision making in the end users best interests in non-traditional medical settings such as at home using any one of several types of communications devices is improved. Usage of the system by patient-subscribers can be tracked for compliance and alerts, reports, messages and surveys issued to health care providers participating on the system including family members and caregivers all to the benefit the end-users health and wellbeing.

### RELATED APPLICATIONS

This PCT application relates to U.S. Provisional Patent Application Ser. No. 61/743,940, filed Sep. 13, 2012, entitled Interactive Communications System for the Coordination and Management of Patient-Centered Health Care Services, Andrew Michael Kluger, Stanley Ian Drew, Miguel Alborg Dominguez and Miguel Alborg Farinos inventors, as well as U.S. Provisional Patent Application Ser. No. 61/688,524, filed May 16, 2012, entitled Interactive Communications System for the Coordination and Management of Patient-Centered Health Care Services, Andrew Michael Kluger and Stanley Ian Drew, inventors, and claims priority to subject matter in-common to both provisional applications, the contents of said earlier filed applications incorporated herein by reference as if fully set forth in their entirety.

### BACKGROUND OF THE INVENTION

1. Field of the Invention

This invention relates to a secure, subscription based computerized interactive communications system for enhancing communications between patient-users and their network of healthcare providers and administrators in community based, non-medical facility settings so as to coordinate the real time flow of information between all the parties involved in the care of the patient-user. Information is shared at the same time by all parties for the purposes of making health care decisions that collectively result in a higher quality of clinical outcomes without the need for providers to query centralized clinical data bases to make real time decisions on the care of the patient-user. The system allows a patient-user to preferentially select those providers of care who are to receive and share said information.

More particularly, in one embodiment it relates to a secure, interactive computer based communications platform which functions with standard telephones, cell phones, stand-alone key pads for attachment to a telephone, smart phones, tablets, laptops, desk top computers, internet television, and the like. All of these devices are configured for one touch receiving and/or placing of audio calls or text messages to and from providers of healthcare related services participating in the care of the patient-user. In another embodiment, messages can instantly and securely be shared between all or certain sub-sets of a patient's healthcare providers. Utilization of the communications system is encouraged through a series of promotions and rewards that are offered to users and their healthcare providers.

2. Related Art

Health care in the US is delivered through a multitude of disparate resources, with information flow between healthcare stakeholders generally restricted for a particular provider of care. In this sense, information sharing between stakeholders involved in the care of patient-users lags the free flow and instant sharing of information of other business industries. Similarly the inability of patient-users or their caregivers to easily share personal health information in real time securely across a spectrum of healthcare providers responsible for their wellbeing has resulted in (1) patients remaining passive consumers of healthcare, and (2) other providers acting in isolation to the detriment of the patient-user. Though connectivity is starting to be established between healthcare providers in the form of digital electronic medical record systems, the ability for healthcare providers to communicate securely with patients outside traditional medical facilities and in their homes and in the community is for the most part still limited to landline phones and fax technology. The existence of patient portals that securely protect personal health information between healthcare providers and patients in their homes and in the community is not well developed for the efficient provision of care to patient-users.

Patient portals are relevant because new healthcare models being touted are structured to be patient-centric, patient empowering, holistically focused, information enriched, and consumer driven. The achievement of this goal is accomplished only through the ability of healthcare providers overseeing a patient-user's care to be in constant connection between themselves and the patient-user such that all participants in the care of the patient-user share information and clinical decisions and actions taken as they are made. This system of coordinated communication leads to coordinated care which is the goal of the new models of healthcare delivery to patient-users. Further, patient portals being web based are conducive to acting as a communications channels to the patient-user for health care information and actionable content that is obtained from large repositories of cloud based data that is subject to analytics and algorithms in a manner that benefits the patient

The healthcare industry's push toward this model is underway through the investigation, development and marketing of new-generational, communication and information tools that aim to create opportunities for real-time connectivity, and that are being aggressively pursued by leading internet, telecommunications and electronics companies. To date, most channels of communication between patient-users and providers are unichannel, limited to sender-recipient email communications that are not shared in real time with other providers that have a stake in the care of the patient-user because of a lack of security safeguards in the transmission of information and the absence of a common connectivity platform between some or all of the other providers of care specifically assigned to the patient-user. In some cases, unichannel email communication involves disease specific or single mission devices and applications which are also limited by restricting the information to certain providers and excluding others thereby missing the goal of complete coordination of information and care. Furthermore, existing email systems lack automatic software applications that allow a patient-user at his direction or request to add new care providers to his network of providers and do so in a manner that meets the required patient-user legal consent. The ability for a patient-user to add new providers to their care network increases the capability and scope of the care they can receive, and improves the quality and clinical outcomes of their health. In another embodiment, patient-users can elect to delete providers from their healthcare network.

For Medicare enrollees whose healthcare needs are the most demanding, cost containment models favor the transfer of financial risk for healthcare services to commercial Health Maintenance Organization (HMO or managed care) insurance companies. Further, under recently enacted legislation, the government is seeking cost reductions through demonstration programs such as Accountable Care Organizations that ultimately rely on influencing the choice and decisions of beneficiaries through effective communication between them and their healthcare providers. Overall, these efforts are directed at providing necessary care that ensures optimal clinical outcomes and doing so in the home and outpatient setting and, where possible, away from high cost facilities (such as hospitals). In addition, criteria that measure the quality of care rendered to Medicare and commercial beneficiaries in an outpatient setting have been introduced by Federal regulators and commercial health insurance plans in order to meet the growing demand by beneficiaries for quality and ‘value’ as part of the governmental and employer based initiatives for increased transparency in the provision of healthcare services.

For every 1000 patients enrolled in Medicare HMO plans, over 320 are admitted into a hospital per year at an average national cost of about $13,000 per admission. Over 50% of emergency room (ER) visits for this same population of patients result in admissions to the hospital, although many of the admissions are deemed inappropriate where the clinical condition could be effectively treated in a non hospital setting. The ability to interdict unnecessary ER visits by pre-emptively deploying resources to the patient at home or in an outpatient setting would result in billions of dollars of annual savings by preventing unnecessary inpatient hospitalizations. In-home nursing, social services and other care are programs are currently offered by many well managed provider networks. The ability of patients to have access to a communication system that could easily alert healthcare providers of their need for care while still in an outpatient setting, would allow these deployable resources to be activated with the possibility of preventing ER visits and in-patient hospitalizations. Communication channeled directly into the patient's home could avoid annual health plan mailings required by Federal regulators at a cost that can reach upward of $6 per enrollee per annum. Further, the fact that over 20% of Medicare enrollees fail to pick up their prescriptions, and that a similar percentage fail to keep scheduled physician appointments, reveals the size and the cost of patient non-compliance in this population of patients.

The “Medical Home” is the end-goal of community based medical care and the focus of the burgeoning home-telemonitoring industry. Technology has expanded beyond simple alarm systems for in-home falls. Current in-home monitoring offers a wide scope of high-tech electronic services for chronic disease management, such as electronic scales, glucometers, blood pressure cuffs, in-home video-tracking, medication monitoring, etc. that measure metrics and report them to a central care-management station. The drive to provide healthcare information in the home in the form of personal health records, disease management programs etc., is a rapidly developing multibillion dollar industry that has attracted prominent internet, telecommunications and electronics companies to this space. At the same time, return of investment for disease management technology has not been forthcoming and to date remains unfunded by the Federal government. Instead renewed focus is being placed on holistic approaches to patient care that emphasize wellness, health screening, early warning alerts, patient driven initiatives that alert providers for the need for care, and incentive and reward systems that encourage patient participation in their own care.

Communication between customers (patients) and healthcare providers (physicians, health plan administrators, etc) is currently disjointed, paper-based, and discontinuous. As a result, customer confidence has eroded in the quality of care and the efficiency of its delivery. Medicare enrollees in managed care plans, commercial plan insureds, and beneficiaries enrolled in the newly created accountable care organizations have a need to communicate with healthcare providers about matters such as the complexity of benefit structures, choice of healthcare providers and delivery networks, customer service concerns such as requests for the authorization of medical services, schedule of preventative care and wellness screening measures, and the poor coordination of healthcare decisions and information sharing between their providers of healthcare. The challenge with navigating the health care system is demonstrated by studies showing that under 1% of enrollees pre-notify a health plan's call center or care advice-line prior to accessing an emergency room.

The ability of patient-users to have their care coordinated among all stakeholders involved in their care by communicating quickly, securely, and easily in real time with their healthcare providers is critical to preventing the patient's decision to seek care outside the home in more expensive medical environments such as the emergency room; to having patients contact their doctors offices or nurse advice lines as a preferential first call for help; and to resolving patients' concerns regarding the quality of care rendered to them.

Typically, the electronic connectivity between providers and patient users is disconnected and fragmented, where communications sent to the patient user by one party for example the doctor, cannot be transmitted using the same communication system so as to reach another care provider, for example the case manager. In such situations the doctor is required to exit the electronic communications system and use alternative systems such as landlines, wireless or facsimile connections. The transmission of information via different communications system results in a breakdown of real time receipt of information and hence the ability to coordinate responses and action by care providers on behalf of the patient.

Likewise the ability of healthcare providers to communicate among themselves based on a patient's request for care is essential for ensuring the proper coordination of medical decisions that collectively make up the care of the patient-user. Poor communication with and between patients, their family caregivers, and their healthcare providers, results in rising costs, substandard clinical outcomes, duplicative testing and redundant performance of procedures, lower quality and customer frustration. Improved communication is vital to the patient's best interest and ultimate wellness. In the face of a more mobile public sector and an expanding senior population with comorbid clinical conditions the demand for transparency of quality and outcomes, lower cost home-based solutions and models that allow for health care delivery in place and aging-in-place are growing.

A number of studies were conducted in the last few years to gauge the responses of seniors to various communications devices such as wireless equipment, a web portal, healthcare equipment, telemonitoring devices, and cell phone technology. From these market studies (November 2006-August 2007) in four locations (Boynton Beach, Fla.; Dallas-Ft. Worth; Southern California, and Honolulu), the most readily acceptable instrument to the market groups was dependent on age. For the elderly, the standard home telephone or mobile cellphone was considered most familiar and trusted. For the younger generation as well as for seniors who are recent Medicare beneficiaries and more accustomed to digital technology, these studies showed greater inclination by patients to utilize hand held or desk top digital communications devices.

Other studies have shown that the lack of health screening and medication compliance and adherence by seniors in particular, contributes significantly to the rise in individual and overall system costs of care. Almost 30% of patients never fill a prescription; about 20% fail to pick up prescribed medication or refills of prescriptions for chronic medical conditions such as diabetes, hypertension, emphysema, and hyperlipidemia. Many patients fail to adhere to recommended health screening tests.

Compounding the adverse effect of this behavior, recent studies show that the elderly with chronic diseases are less likely to be Internet savvy and not as well informed about their disease states. Seniors are apt to be vulnerable, anxious, and cognitively impaired. Many suffer from social isolation and ensuing depression. Regular reminders to order, take, and reorder their medications, coupled with the easy access to friendly voices at the other end of the line on a familiar device like their own telephone, can be a critical factor in encouraging medication compliance

The need for long term care is escalating. People 85 and up comprise fastest growing segment of the population. The affordability of long term and institutionalized care is beyond the reach of most people. Costs of long term care outside the home such as assisted living is prohibitive. The ability to age in place, and have care delivered to the home is one solution. To do this, in-home communication between patients, caregivers and professional medical providers is a critical first step. What is required in this dynamic environment are home-based or mobile applications that meet the needs for simplicity and have low (or no) out-of-pocket costs. That is, to provide patient-users and all their healthcare providers with an easy-to-use communication platform that allows for timely and secure connectivity to and between each stakeholder so that information and clinical decisions based on the information can be shared among all participating healthcare providers of the patient user, and the patient themselves. In this manner the care of the patient-user is coordinated to their benefit.

In an era of medicine driven by patient choice and decisions made based on value, typified by Accountable Care Organizations, patient engagement and customer relationship management are key factors in attracting, retaining and servicing patient users to the level of their expectations. Using patient portals, communication to patient end users in social networking language in order to develop relationships with patient users, is becoming relevant as a tool to increase patient loyalty, trust and commitment to participate in their own healthcare needs. Communications formatted as hard and static data points such as found using electronic medical or electronic health records is not conducive to relationship development that is sought by patient users from their care providers.

### SUMMARY OF THE INVENTION

A telephone like device was described in commonly owned and now abandoned U.S. patent application Ser. No. 12/586,334, filed Sep. 21, 2009, (the contents of which application are incorporated by reference herein as if fully set out in its entirety) to address many of the problems discussed above. The device featured direct-dial push buttons, with the buttons individually assigned to the patient's physician, caregiver, pharmacy, transport vendor, case manager, durable medical equipment provider, and medication reminders, with additional buttons made available for such things as social networking. The device was designed to be patient-centric and aggregated many important healthcare needs into a single instrument for the home.

Because of the known industry inefficiencies in telephone outreach programs that attempt to reach patient/customers, a design feature of the health phone was the capability to light up each button in the event a call was not answered, much the same as a hotel pone message button. Further research identified button colors best recognized by aging eyes, in addition to imprinting Braille on each button. Because some seniors are accustomed to moving locations and changing their healthcare providers, the capability to reprogram the buttons remotely without the involvement of the subscriber-customer was also developed. An additional feature was the incorporation of Bluetooth and ZigBee technologies into the device that allowed third party home-based telemonitoring devices such as electronic scales, glucometers to interface with the device for the transmission of data.

An alternative device, a key pad appliance with similarly dedicated buttons was also described in that same application, the appliance designed to connect with a regular telephone to provide that phone with all the same functionality as the health phone. Since the development of those two specialized analogue devices, the system has been further developed to incorporate new platforms such as digital devices including mobile phones, smart phones, tablets, laptops, table top PCs, and internet connected TVs.

According to one aspect of the instant invention an electronically monitored interactive system for monitoring medical care is described including a web based interactive communications system for alerting a patient-user (also throughout the remainder of the application o referred to as patient-subscribers) to the need to take a certain action relative to their health, such as the taking of a medication, keeping a medical appointment, completing a certain healthcare report or survey, contacting a case manager, pharmacist, caregiver, and the like. The interactive system is programmed to monitor responses to a communication by the system to see that the required action has been taken, such as listening and/or responding to a message, generating a report on which basis action can be taken by a healthcare provider, placing a return call, and the like. In an embodiment of the invention, once the required acknowledgement to the message is made, the response is documented and a notice automatically sent to the appropriate healthcare provider(s) as to the content of the response or action taken by the patient-user.

In another embodiment, end users of the interactive communications system such as s are able to selectively send copies of the content of their messages or reports to other users on the system such as healthcare providers, caregivers, family members who are participants on the systems. In this way other users of the system can share in the information sent by a patient-subscriber to a healthcare provider and be kept informed of the patient's health care status and needs. Information on the patient-user obtained simultaneously and collectively by all parties participating in the patients care, results in higher quality of care and clinical outcomes. The number of users to whom messages can be copied by the patient, the patient-users Care Network, is defined at the sole discretion of the patient and determined by the number of users who have opted to participate in the Care Network of the patient.

Because in some embodiments the system can simultaneously connect to all permitted/enrolled users in a global Care Network, the system can share information in real time between the patient, family caregiver, family members and other patient healthcare providers. In addition, the system platform can also be programmed to include healthcare managers, administrators, or management teams that are engaged in the patient-provider network.

In one embodiment of the invention, each response by a patient-user to a message query such as a reminder, survey, or health instruction that is sent by a healthcare provider to a patient-user, is deemed to have “actionable” potential. In another embodiment, if an incoming call/message is not responded to after a predetermined interval of time, an electronic note is automatically placed in the patient's digital file and notices sent to the patient-user's assigned doctor(s), other health care providers, caregiver, family member, network administrator and/or manager, who in turn can act on the information as appropriate.

In another embodiment of the invention, where the communications device is equipped with Bluetooth or wireless capability, home monitoring equipment that likewise has Bluetooth capability can be linked to the communications device, and monitoring reports sent to the provider server system for forwarding to a health care provider participating in the interactive communications system platform or is part of the healthcare delivery network connected to the System. In yet another embodiment, the communications system includes software capable of detecting a significant departure from the normal condition or measurement that may indicate a need for medical intervention, in which case a medical alert can automatically be sent to the patient-user, or their healthcare provider, such as a designated physician, nurse, care giver and/or emergency responders, as the case may be. In yet another embodiment, the communications system can include software capable of detecting patient-user answers to health surveys and questionnaires that alert healthcare providers to gaps or needs in the patient's care that allows for appropriate remedial action.

In a still further embodiment, to encourage participation in the use of the system, incentives in the form of a reward system can be provided. In one embodiment the reward system includes points issued to the patient-user of the system, which points are redeemable for prizes and other rewards. Points can automatically be issued and credited to the account of the user electronically, regardless of whether the user responds by analogue phone, a digital communications device, or manually through a call center. In one embodiment, points are issued for simply engaging with the system such as by listening to medication reminders and health provider messages, completing certain health care and quality and customer satisfaction reports, participating in a survey, listening to a health wellness message, and the like.

System software is programmed to notify a patient-user of messages, reports or reminders sent to them by a healthcare provider. Messages sent to patient-users are generally categorized as (1) free text messages, (2) medication reminder messages, (3) non medication reminder messages, and (4) a healthcare surveys and questionnaires each designed to solicit certain responses that are important for the wellbeing and continued good health of the patient-user. In addition certain questionnaires are designed to assist healthcare providers manage transitions in the patient's care such as from hospital to home or from hospital to a nursing facility and establish patient-centric care plans based on their care needs. Medication reminders can be set by the patient himself, or a person with system administrative privileges at the direction of the patient. Medication reminders appear on the patient-subscriber's reminder calendar and can be changed or deleted at the discretion of the patient. Non-medication reminders can be set up by providers involved in the patient's care and can be posted to a reminder calendar of the patient-subscriber or in their alert mail inbox. For telephones, medication reminder take the form of actual calls made by the system to the subscriber's landline telephone or cellphone, these calls timed in accordance with a caregiver or patient directive. In one embodiment up to 4 reminder calls can be delivered in a 24 hour period.

Other variations, embodiments and features of the computer based interactive home health care monitoring and information system will be described below in the Detailed Description of the invention.

### BRIEF DESCRIPTION OF THE DRAWINGS

So that the above-recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a GUI for a telephone like appliance as described in our earlier filed patent application Ser. No. 12/586,334.

FIG. 2 is an illustration of a GUI for a keypad appliance also described in our earlier filed Ser. No. 12/586,334 application.

FIG. 3 is an illustration of an exemplary GUI for an electronic communications device according to another embodiment of the invention.

FIG. 4 is a flow chart illustrating the operation of the back end processing of a medication reminder.

FIG. 5 is a flow chart illustrating the operation of the back end processing of a non-medication (i.e. standard) reminder.

FIG. 6 is a flow chart illustrating the operation of the back end processing of a Doctor's Office Report Request to a patient-subscriber

FIG. 7 is a flow chart illustrating the operation of the back end processing of a Doctor's Office Alert to a patient-subscriber.

FIG. 8A through 8L are various screen shots of an exemplary GUI illustrating how the presentation of a feature might appear to a subscriber on the screen of their computer or portable digital device according to various embodiments of the invention.

### DETAILED DESCRIPTION OF THE INVENTION

The invention comprises an interactive computer supported health care communications system which facilitates the secure and confidential connection between all parties participating on the system and coordinates the sharing of information between the parties as well as the timing, delivery and content sharing of information and actions taken between all participating parties such as healthcare providers including caregivers, friends, family members and a patient-user in an in-home and/or mobile community setting, including the transmission of certain health care messages in the form of patient directives, alerts, messages, surveys, questionnaires, reports, medical notices, medication reminders (such as taking medication, keeping a doctor's appointment, and the like), the furnishing of medical and general information (such as medically related infomercials), as well as serving as a communications platform for allowing medical management oversight organizations to have real time access to the communication between participating healthcare entities in the network, including the patient, for the purposes of providing medical management services, resources and assistance; and as a platform for advertisers to reach and incentivize users of the communications system to promote wellness through the offering of health care products, goods and services of interest.

The computer based interactive communications system involves several different communities or categories of users. These include the system operator, the end user/subscriber (alternatively the patient-user or patient-subscriber), and the medical community dedicated to the providing of care to the patient-user, including doctors, nurses, case managers, pharmacists, etc., and non professional caregivers, family members or friends of the patient, as well as vendors of health related services such as transportation providers, pharmacies, home nursing services, walk in clinics etc.

The term “system operator” refers to the entity responsible for the operation and maintenance of the computer based system. This can be a private entity such as a health service company, customer contact center, insurer, hospital, medical facility, assisted living facility and the like.

The term “health care provider”, as used herein, includes doctors and nurses, case managers, pharmacists, and can refer as well to professional home care assistants, family members and the customer service center that acts as a contact center resource to health care providers and patient-users and subscribers.

The term “end user” as used herein applies to users of the system, also referred to from time to time as subscribers, patient-subscribers, patient-users, end-users or customers. These are the persons for whom the interactive communications system of the invention is designed to assist with the management and coordination of their personalized health care management in the home setting and outside of traditional medical facilities. In one embodiment, doctors, and other health care professionals can also be end users. In another embodiment, administrators of the network of health care providers and patient-subscribers or users, as well as system operators (i.e. health plan administrators) can be end users.

The term “button” as used herein denotes a pressure sensitive button on a telephone-like appliance, or keypad-like device used with a regular telephone, as well as the virtual buttons (i.e. graphic icon displays) appearing on the display screen of a smartphone, tablet laptop, desktop PC, traditional PC, or smart TV, the virtual button activated when touched or selected using a computer mouse. In the discussions following, the term button is used interchangeably with graphic icon, and term “pushed” is used interchangeably with touched or selected, these actions achieving the same result.

The service providers identified by the buttons of the system are interchangeable, customizable and can be branded in accordance with the business model and Care Network of the entity utilizing the features and functionalities of the Invention. A button for example can in one instance be assigned to a pharmacist and in another a transport service. The number of buttons assigned to services and programs and providers can differ in accordance with the business needs and goals of the entity employing the communications platform.

The Interactive GUI

For electronic communications devices, the graphic user interface (GUI) of the invention employs a plurality of icons, wherein each button/icon is assigned a particular function, and when touched is programmed to accept an incoming call/message or dial out to the phone number of a designated provider.

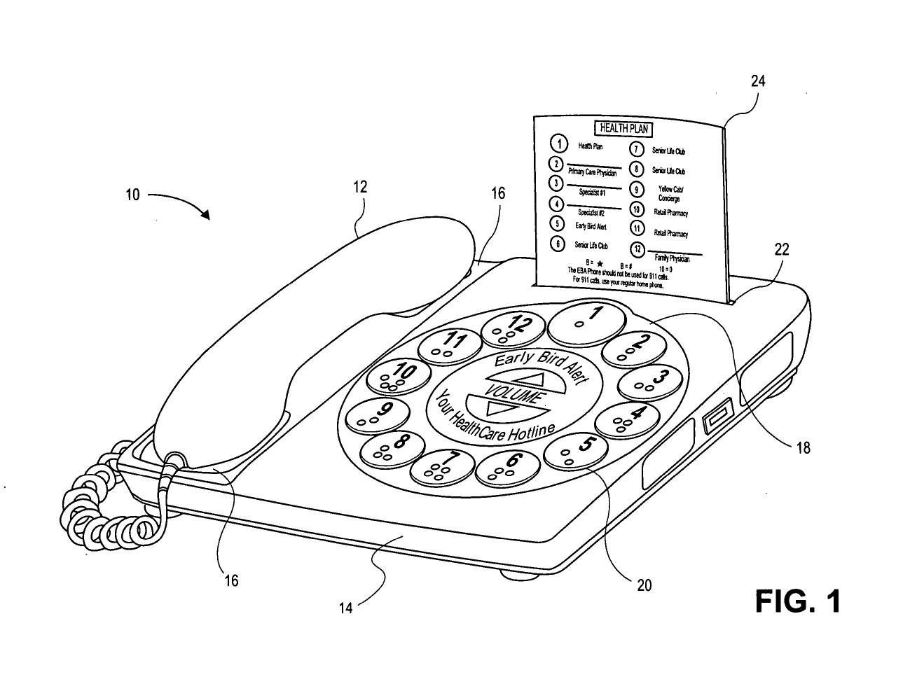

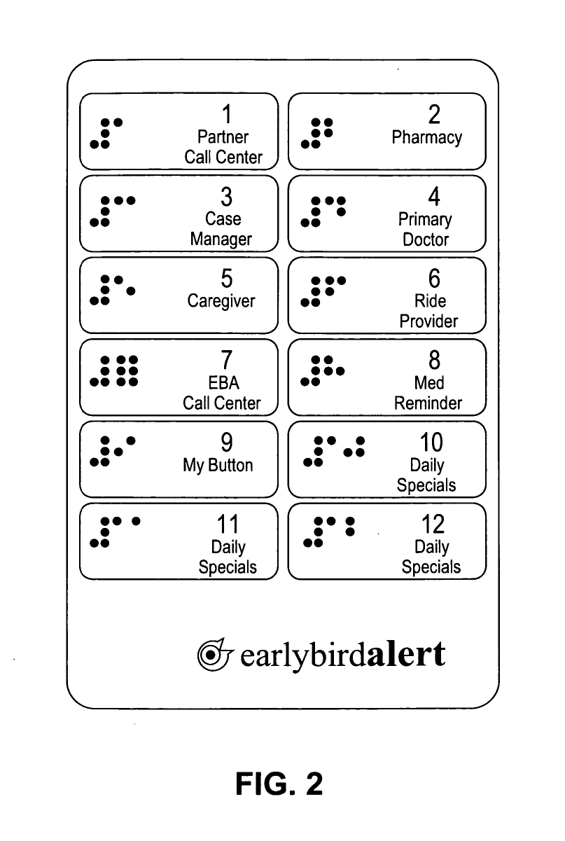

The GUI for the telephone like device of our earlier filed application Ser. No. 12/586,334 is illustrated at FIG. 1, and GUI for the related key pad device (described in that same application) illustrated at FIG. 2. The phone based device 10 of FIG. 1 includes a base 14 incorporating a cradle 16 for handset 12 and features a dial face having a circular clock-like arrangement 18 of pressure sensitive buttons 20 activated by touch and that can be color coded for the specific assigned function of each button. In the illustrated embodiment, each of the twelve pressure sensitive buttons may be mechanically activated push buttons. Slot 22 is provided to hold a card 24 which describes the allocation or assignment of the buttons on the phone face.

In one embodiment, the device directs an incoming call to the dedicated, color coded button to which it has been linked, and blinks to indicate which button needs to be pushed to answer the call. In another embodiment, if the call is not answered, a message can be left as a voice mail, the dedicated button now remaining lit until pressed to play the message. In yet another embodiment, the message can be left by the sender in the cloud, which message is retrieved by the user when connecting with the cloud such as by dialing an 800 number.

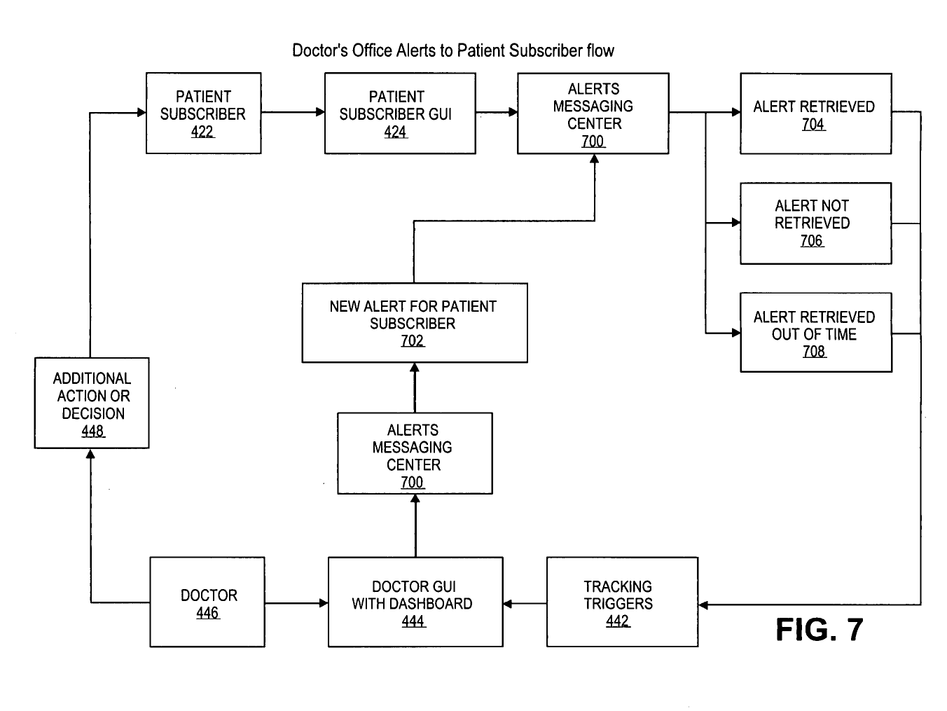

With either the phone or key pad appliance, the buttons are lit much like the message waiting light of a conventional phone, and the light turned off when the button is pushed to listen to the waiting message. For a further discussion of these appliances, reference is made to our earlier filed patent application, the content of which application is incorporated herein by reference. Further details regarding the operation of these devices and their supporting electronics can be found at FIG. 7 of application Ser. No. 12/586,334 and are discussed in the related sections of that application.

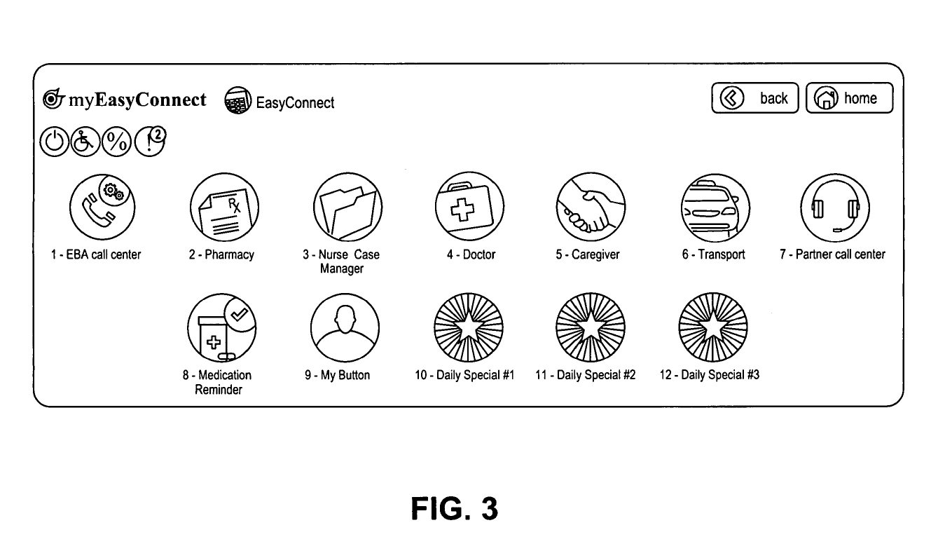

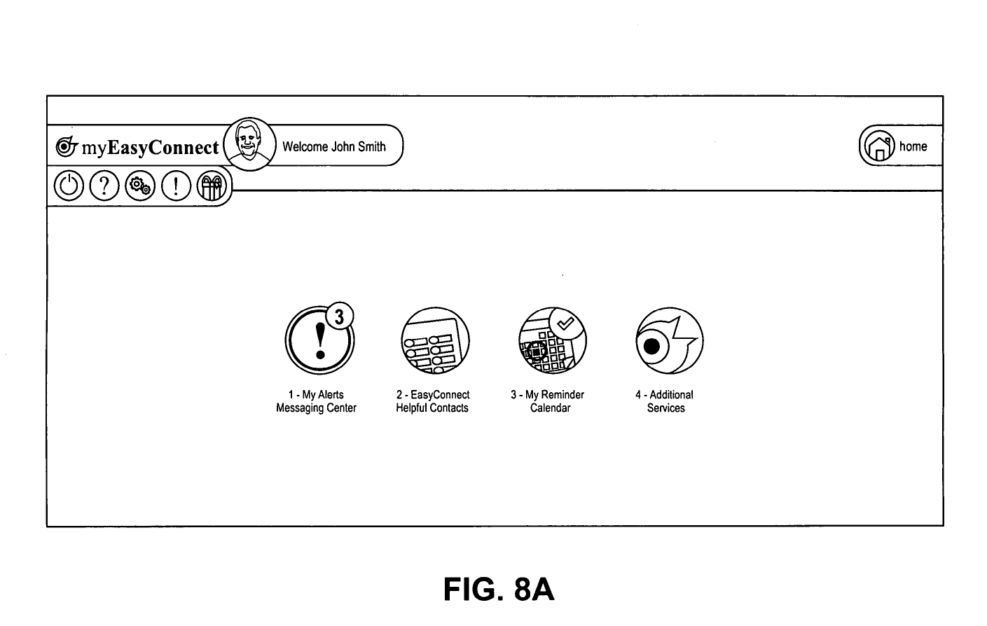

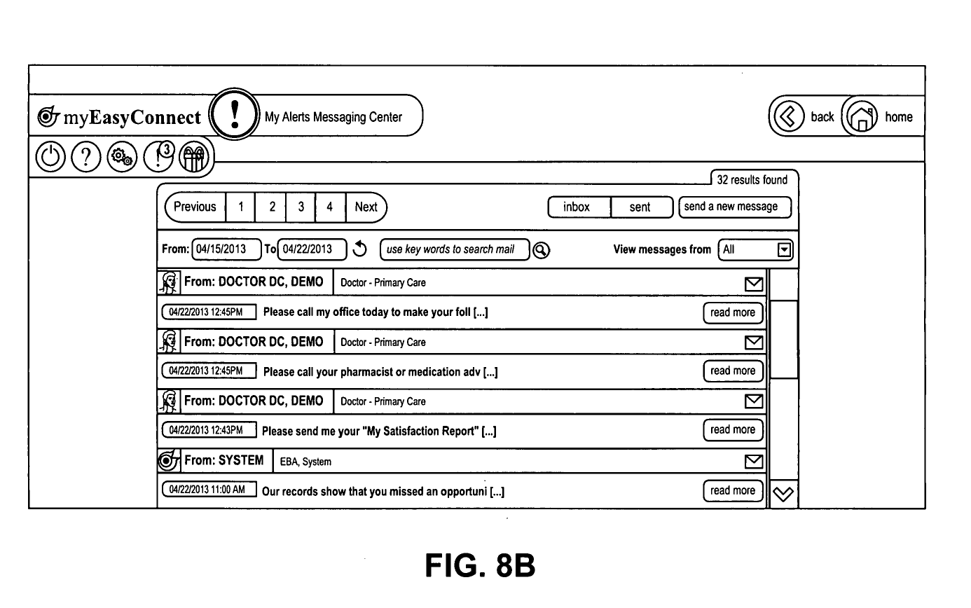

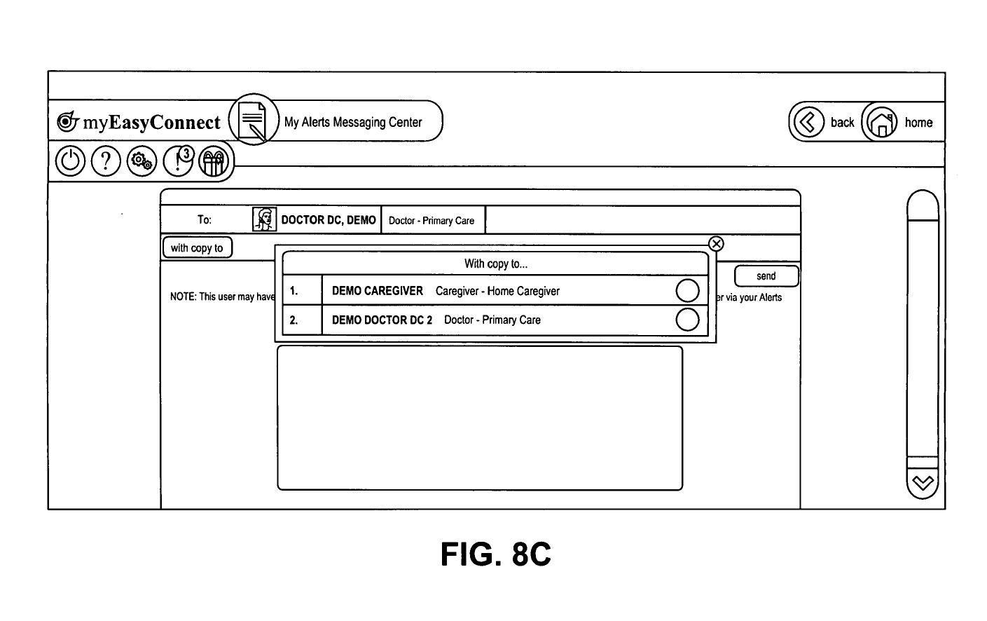

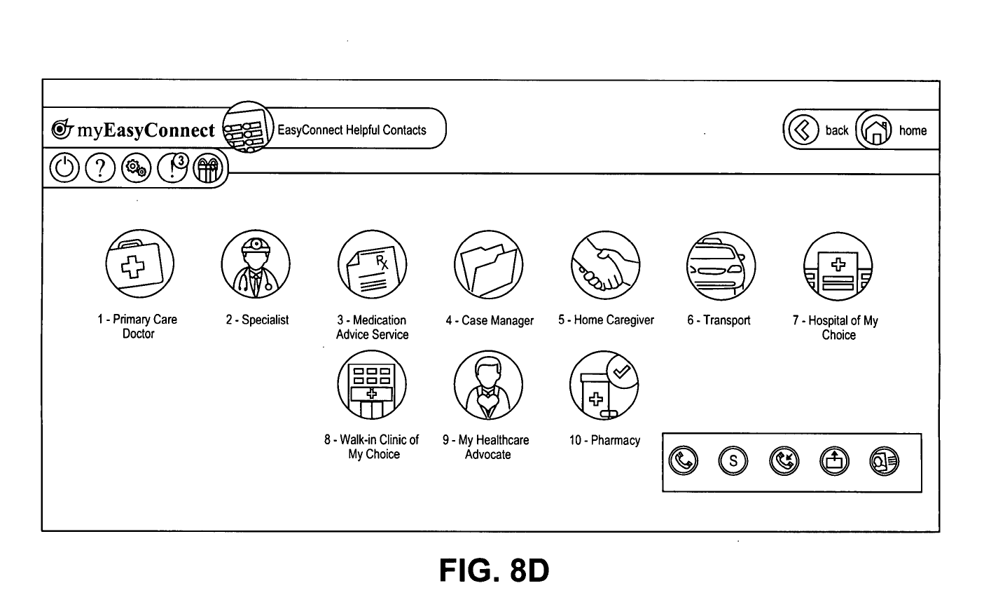

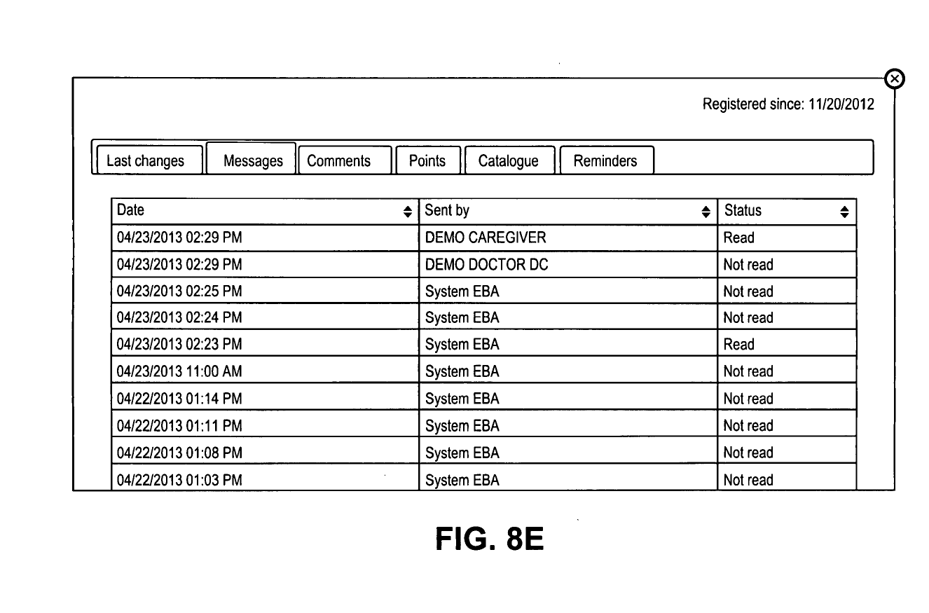

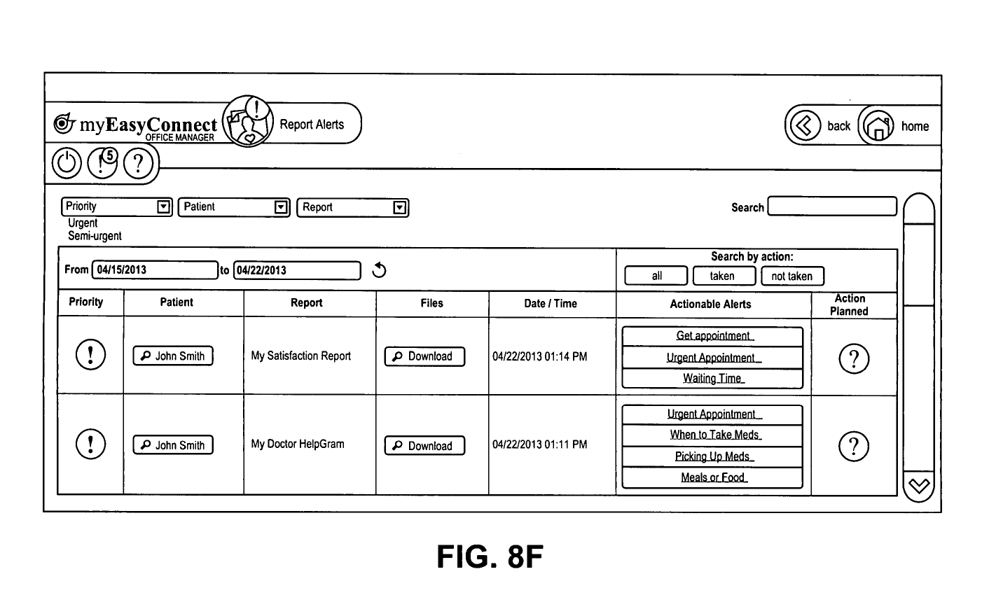

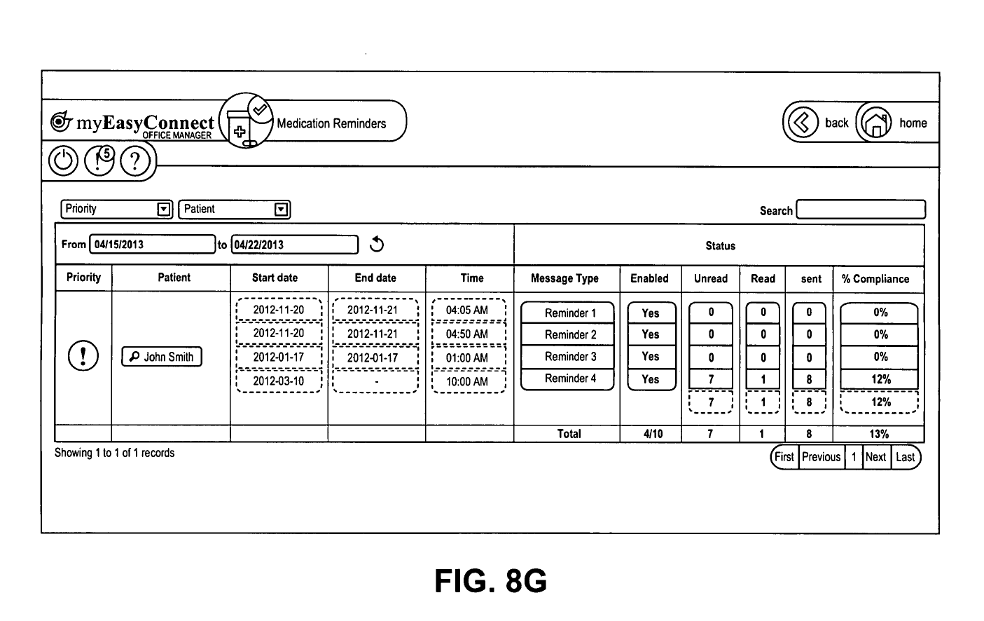

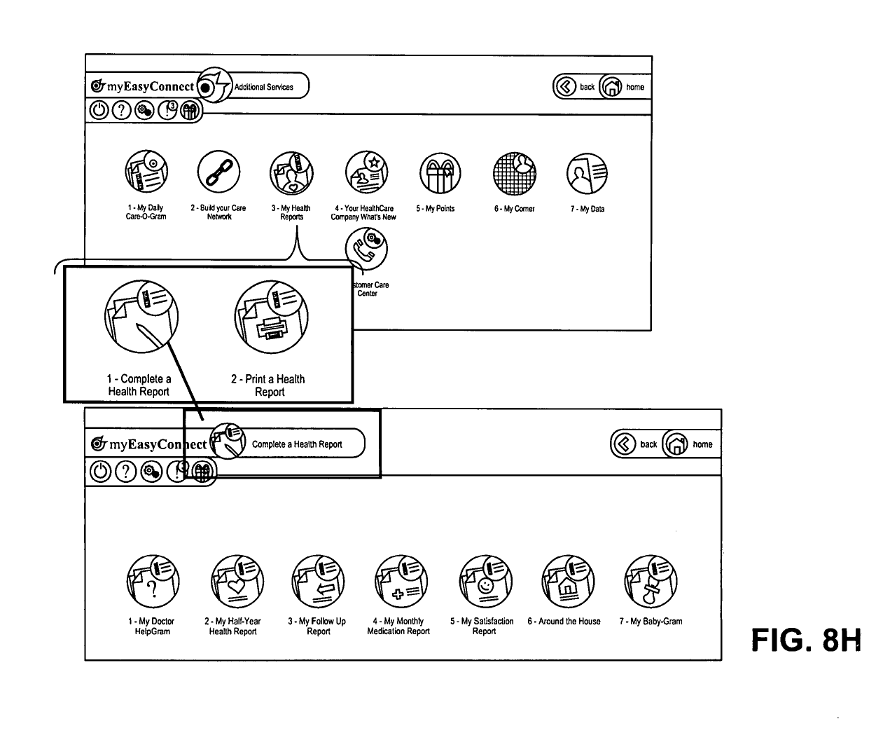

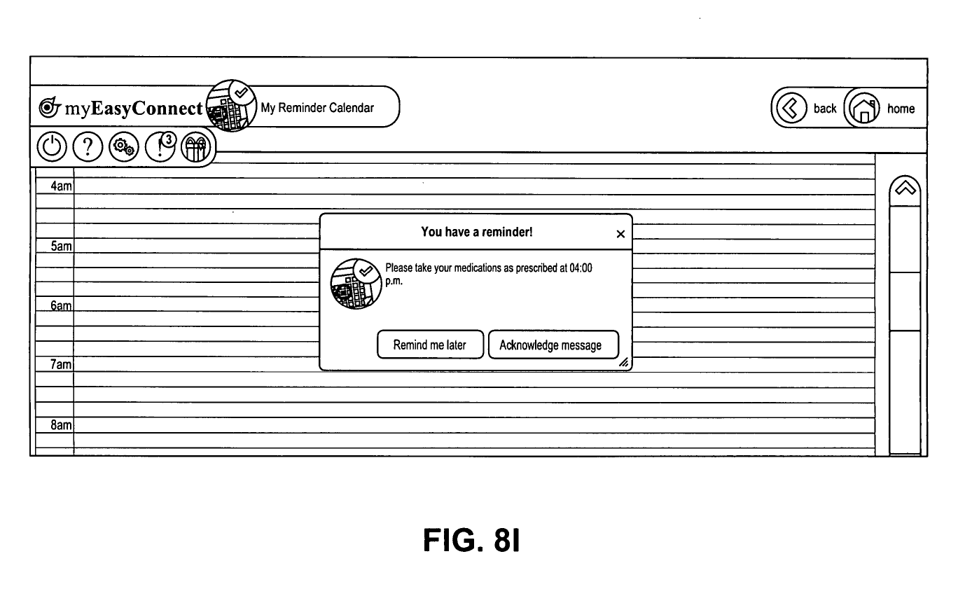

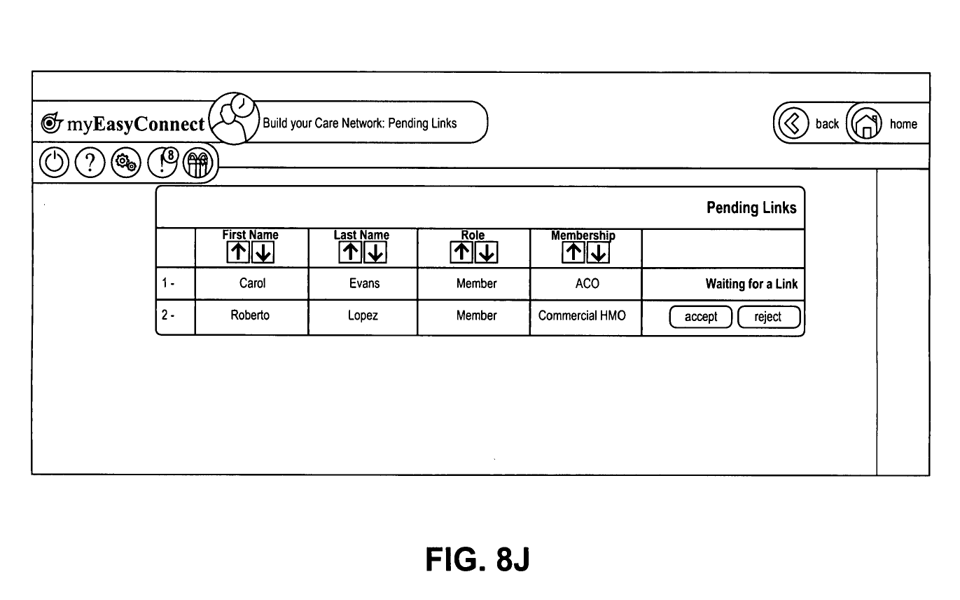

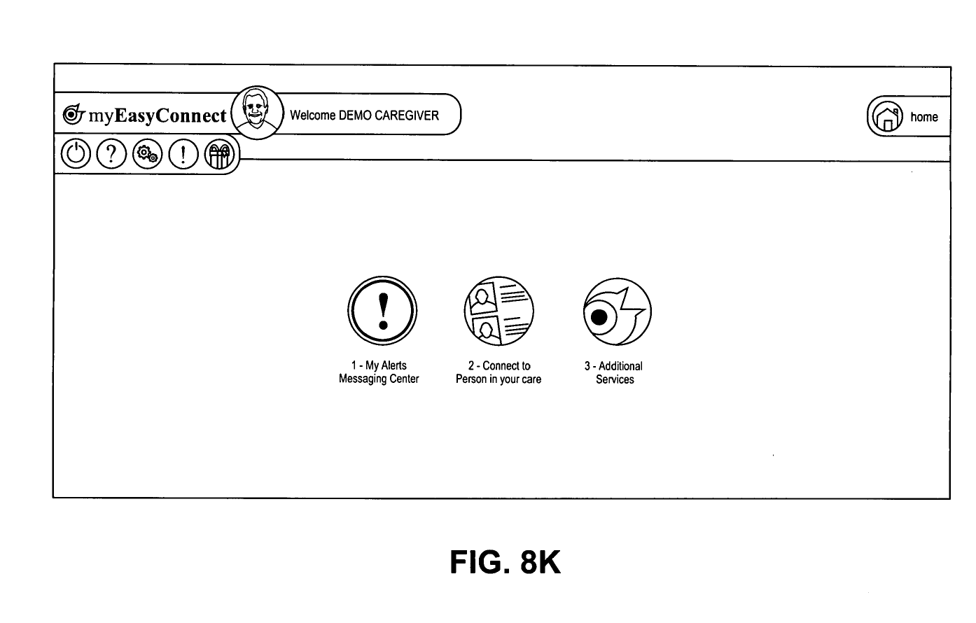

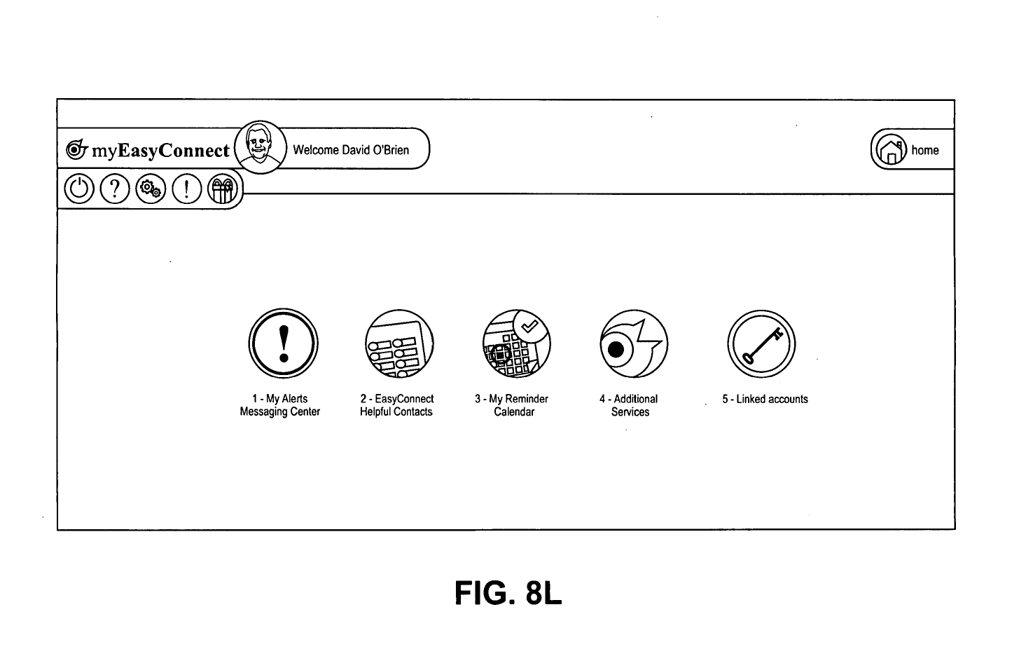

The GUI concepts for those earlier described appliances have been adopted for use with digital/wireless communications tools popularly in use today such as a smartphone, tablet, PCs, etc. While the push button numbers used with the phone related appliances of the earlier application can be used as designators for the virtual buttons of the GUI of these electronic communications tools, graphical icons can also be used, exemplary icons illustrated at both FIG. 3 and FIG. 8A-8L. It is to be appreciated that other symbols/icons can be used without departing from the scope and spirit of the invention.

Similarly to the lit or blinking buttons of the phone/keypad, the icons can be electronically activated by a number of visual cues, such as brightening or flashing. By way of example, the opening or home screen/display of the communications system according to an embodiment of the invention is illustrated at FIG. 8A, which home screen, may include a “My Alerts” button (or otherwise named My Alerts Messaging Center) programmed to display a number count in proximity to the button, the number count indicating the number of messages waiting to be reviewed. In the case of a smart phone touch screen, by touching an activated button the subscriber is taken to a next screen such as illustrated at FIG. 8B, which displays all pending messages, be they a delivered voice or text message, which can be heard or read. The response may thereafter be provided or “copied to” the sender of the message, as well as other parties previously designated by the patient-subscriber (i.e. connected to the patient's personalized healthcare network of healthcare providers [see FIG. 8C]).

Assignment of Buttons/Icons

Whatever the nature of communications device, it is provided with dedicated buttons, in the case of a phone type appliance, or dedicated icons in the case of a smart phone, tablet, PC or smart TV. The icons operate in the same manner and provide the same functionality as the phone buttons. How many and what functionalities are ascribed to the buttons or icons is of course a matter of choice, the assignments to be determined by the operator of the communications service with input from the subscriber.

With electronically based communication devices the assignments of the buttons can but need not necessarily be the same for the different communications devices illustrated at FIGS. 1 and 2. Further, with screen based electronic devices each virtual button or icon can be assigned subordinated buttons that are accessed by the selection of the primary button thereby enlarging the scope of service and functionalities available to the subscriber. The number of primary icons can match the number of buttons on a phone or combinations thereof. Of course, in other embodiments using a smart phone or PC, additional buttons can be provided, with different assignments. In still other embodiments, the button or icon assignments can be changed depending on the system operator or the manager administrator overseeing the provider and subscriber network.

With reference to FIG. 2, exemplary assignments include: (1) System operator call center, (2) pharmacy resource (3) case manager, (4) primary care doctor, (5) caregiver/family/friends, (6) transportation vendor, (7) system provider call center for technical oversight of systems electronics and engineering, (8) medication reminder, (9) My button assigned to personalized and customized programs and services pertinent to subscribers, (10) Daily Special #1, (11) Daily Special #2, and (12) Daily Special #3. The number of buttons/icons as noted before is not critical, and can be more or less than those illustrated. Also the particulars of button/icon assignments or the order of assignments is not critical as more than one button can be dedicated to doctors or caregivers, and other assignments can be made to other providers depending upon the needs of the user/subscriber and/or the services provided by the system operator.

In the case of digital communications tools, by selecting one of the dedicated GUI buttons, a menu of sub files can be opened, as illustrated in FIG. 8H to display a drop down menu containing a plurality of additional icons, thus providing an enriched content field. By way of further illustration, under the specialist icon illustrated at FIG. 8D, upon selection, a drop down menu appears listing one or more specialists according to their specialty. Similarly, with the home caregiver icon of FIG. 8D, touching that icon opens up another drop down icon menu listing several different categories of caregiver, including family members and/or friends.

The use of dedicated buttons/icons enables one touch connections between subscribers-patients and their providers of health care services. As pushing a highlighted button automatically connects the provider linked to that button, it is not necessary for the subscriber to remember providers' phone numbers, or have to look them up. Being able to simply touch a button/icon to make a call greatly simplifies the process.

The general architecture of the buttons/icons is reproduced with specific customization of each button/icon based on the community or category of end-user subscriber such as doctor, patient, caregiver, caregiver with a dependent, healthcare administrator or medical management organization and the type of needs and responsibilities enacted by the subscriber. The icons are designed to be simple to decipher, are in bright colors, and are arranged in an array on the display screen to provide the subscriber with access to a comprehensive network of healthcare providers, health care services, resources, programs, information on behalf of the subscriber such that the subscriber can receive information relevant to their health and wellness or can send information to other healthcare providers or subscriber end-users with the same goal.

Interactive Features

IVR Feature for Analogue Phones

For subscribers linked to the system by ordinary analogue telephone, an IVR (interactive voice recognition) system can provide the same functionality as buttons/icons. The IVR program scrolls the subscriber through an audio menu so that the user need not remember which number on the phone is assigned to which specific healthcare provider or service. A legend card can also be provided for display by the phone which contains this very same information. Non-medication messages, alerts or reports can be left for the subscriber as voicemail messages, stored at the central server facility. In this way healthcare providers, caregivers and others can leave voice mail alerts in the computer cloud whereby subscribers, by dialing a toll free number, can access the cloud to retrieve these messages.

Messages can be stored for a set period of time, in one embodiment for up to 24 hours, and then archived. Upon accessing the system, patients are notified of the number of alert messages, if any, pending in their voice mail inbox. Once the subscriber dials the cloud, the subscriber can listen to alert messages or complete a health related questionnaire or survey using touch buttons or advance to the menu of button options that if pushed, connect the subscriber with the provider linked to that specific button. Each alert offers the subscriber the opportunity to connect with the provider who sent the alert. In one embodiment, the system can also be programmed to identify up to two members of the same household. Upon entry to the system, subscribers are welcomed, asked to authenticate themselves and told to press 1 if they are subscriber #1, or press 2 if they are subscriber #2. Based on the response, the appropriate voice mail inbox is accessed.

Reminder Functions

A feature of the interactive communications system is the computer managed capability to forward automated reminders to patient-users, such as daily reminders to take medication at a certain time. In addition other non-medication reminders, messages and reports with other content pertinent to subscribers can be forwarded. In one embodiment, messages, alerts, surveys, questionnaires sent to the user by a healthcare provider, result in an email notification occurring in the user's regular email outside the interactive communications system of the invention whereby the user is requested to access the system using their password to receive the full report from the health care provider. Such communications serve to drive users to the system for important communications that they otherwise may not access in the absence of a request to do so appearing in their regular non-system email. Reminders can be programmed either by the system operator or administrator on behalf of the subscriber, or in the case of the wireless smart phone or web based embodiments of the system, programmed reminders can be set up by the patient-subscribers themselves. Reminders and messages can be programmed on a flexible schedule or calendar basis. In one embodiment, a reminder icon is assigned to the home screen of the system, as illustrated at FIG. 8A, icon #3. Touching the icon will take the subscriber to a reminder screen, such as illustrated at FIG. 8I. Once the subscriber retrieves and listens to the reminder or message, in an embodiment adapted to both landline and cellular telephones, the system is programmed to automatically clear the item, and the subscriber's action or lack of action is electronically recorded. In one embodiment illustrated at FIG. 8I, the subscriber can either electronically acknowledge the reminder or request to be reminded later.

The back-end of the interactive communications system, managed by specialized computer software programs, allows users (such as patient-subscribers, doctors and caregivers) and those acting on their behalf (e.g., system operators or administrators) to set up, in one embodiment, both Medication and non medication reminders.

Medication Reminders are available only for patientubscribers and if set by the systems operator, can be generic messages to patients such as “take your medication as prescribed” (FIG. 8I). Medication reminders are repeated on a daily basis and, in one embodiment, a unique patient-subscriber can program or have up to four medication reminders programmed for delivery at different times during a single 24 hour period. Non medication reminders or medication reminders set by the patient-subscriber can be free-text based reminders.

Reminders can be linked, similar to other features like alerts, to specific tracking triggers that monitor an end user's response to these reminders. The response or lack thereof by patient-subscribers to reminders are measured and can be flagged by the system and then reported electronically so as to appear on the GUI of healthcare providers, such as illustrated at FIG. 8G, who can use the results to assess the compliance of users to messages, questionnaires, alerts sent to users and thereupon take appropriate action for the benefit of the patient.

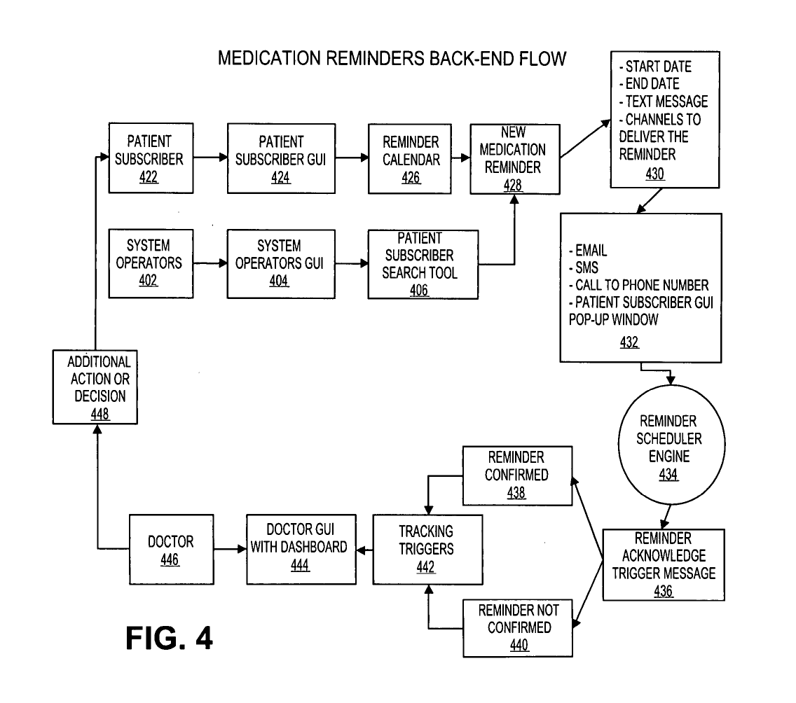

The program flow for the reminder system, along with the track and trigger functions are depicted in FIGS. 4 through 7, and further described below.

Medication Reminders

Medication Reminders and messages (FIG. 4) can be programmed on a flexible schedule or calendar basis, such as reminders to take a medication at a specific time and on a specific date. The patient-subscriber can retrieve the reminder, by reading or listening to the reminder message. The system is programmed to have the patient-subscriber actively acknowledge the reminder by interacting with the system (FIG. 8I), and to record the patient's action or lack thereof.

Patient-subscribers (FIGS. 4, 6, and 7, box 422) are able to set up a medication reminder on their own when accessing and using the patient-subscriber GUI (424). They do this by accessing a common Reminder Calendar GUI (426) where the dates and times for Medication Reminders (428) can be selected. Then, the patient selects a start and end date for the medication reminder, created using an interactive screen menu (430), including a date calendar, an alert hour for the reminder, a text for the reminder, and the communication channel (432) to be used to deliver the reminder.

Resident in the server system are computer software subroutines for managing the medication and non medication reminder features, also known as the Reminder Scheduler Engine (434). This server system software directs the storage of selected information for each patient-subscriber registered with the system who has elected to receive programmed reminders either set up by the system operator or set up by themselves using their Reminder Calendar function. Once a reminder is created, the Reminder Scheduler Engine creates a delivery-schedule queue that is responsible for sending out all reminders. This task is updated on a minute by minute basis so as to allow new reminders to be added and included in the scheduler queue or be deleted from the queue. Based on the programmed scheduling of the reminders, a patient specific reminder is sent to the patient. Information related to tracking is collected, updated, stored and redistributed (when needed) by the Reminder Scheduler Engine to other users of the system (e.g. doctors).

If a patient-user acknowledges receipt of a reminder, the Reminder Scheduler Engine stores this reminder message as acknowledged. This information can be provided to healthcare providers who track the patient's compliance with medication and non medication reminders (see for example FIG. 8G) so as to create corrective action plans. If a patient-user does not acknowledge the reminder, the system will prompt them with the same reminder message one more time (in one embodiment 50 minutes after the first acknowledgement request). If no confirmation is provided, the Reminder Scheduler Engine will update the reminder status, in an exemplary embodiment, to that of “not reviewed” or “unread” and this information can immediately be shared with healthcare providers tracking the patient's reminder responses and noting whether a reminder has been reviewed or not.

Reminders can be sent by one of several messaging pathways or channels, including:

1. Email: If the communications system holds a valid email address for the patient-subscriber and the patient-subscriber has selected this channel for receiving a medication reminder, they will get an email reminder message at the appropriate date and hour. The patient-subscriber can acknowledge receipt of the reminder (436), in one embodiment, by clicking over a confirmation link (438) in the reminder email.

2. SMS (Short Message Service): If a patient's digital file includes a valid mobile phone number for the patient-subscriber, with confirmation that the subscriber has an SMS text messaging plan, and this channel selected to receive medication reminders, at the appropriate date and hour an SMS reminder message will be sent. The back-end of the interactive communications system will treat this reminder as acknowledged if the SMS is successfully delivered to the patient-subscriber's mobile phone. When the SMS message is delivered, the mobile network automatically issues a confirmation with a time stamp for the delivered message.

3. Call in to a landline or mobile phone number: If a patient's digital file includes a valid mobile phone or landline number, and this channel is selected for receiving a medication reminder, the subscriber will get a call to the selected phone number at the appropriate date and hour with the reminder message. The back-end of the interactive communications system will treat this reminder as acknowledged if the patient-subscriber accepts the call to hear the reminder when prompted to identify themselves by providing an acknowledgement of their name. In one embodiment, if the channel selected is “call to a landline” or “call to a mobile line”, and the patient-subscriber has also selected the SMS channel, the patient-subscriber will be prompted to choose between either the landline/mobile option or SMS option. Further, while medication reminders can be delivered by all channels above, non-medication reminders in one embodiment are only delivered by SMS or Email.

4. The GUI pop-up box: The pop-up box is a window that appears at the proper date and hour with the reminder message. An “Acknowledge Reminder” button, in one embodiment, is presented in this pop-up box for the patient-subscriber to confirm receipt of the reminder by clicking on the reminder button. For wireless applications of the program, reminders such as a Medication Reminder can include an audible beep as well as a visual “pop up.”

In certain circumstances setting up a medication reminder can be performed by system operators (402, 404), or those providing support to patient end users such as caregivers of dependants such a parents of under-age children who are acting on behalf of those users not directly interacting with their own GUI. System operators who have the requisite authorization can identify patients requesting a medication or non medication reminder by using a “Patient Search Tool” (406) to identify the specific patient-subscriber for whom the reminder is to be set. Using the Patient Search Tool, an authorized system operator can browse the system's entire database of digital patient files to look the data files specific to a particular patient-subscriber and set, update, delete, and/or modify reminder messages. This same Patient Search Tool allows system operators to manage and update important patient and healthcare provider and administrative data such as contact numbers, email addresses, passwords, authorized connections with other users, registration of new users, selected communication channels for the delivery of messages, etc. Once the desired patient-subscriber's digital file is located, the system operator can set up a reminder that is fully customized to that specific user's needs and preferences.

Non Medication (Standard) Reminders

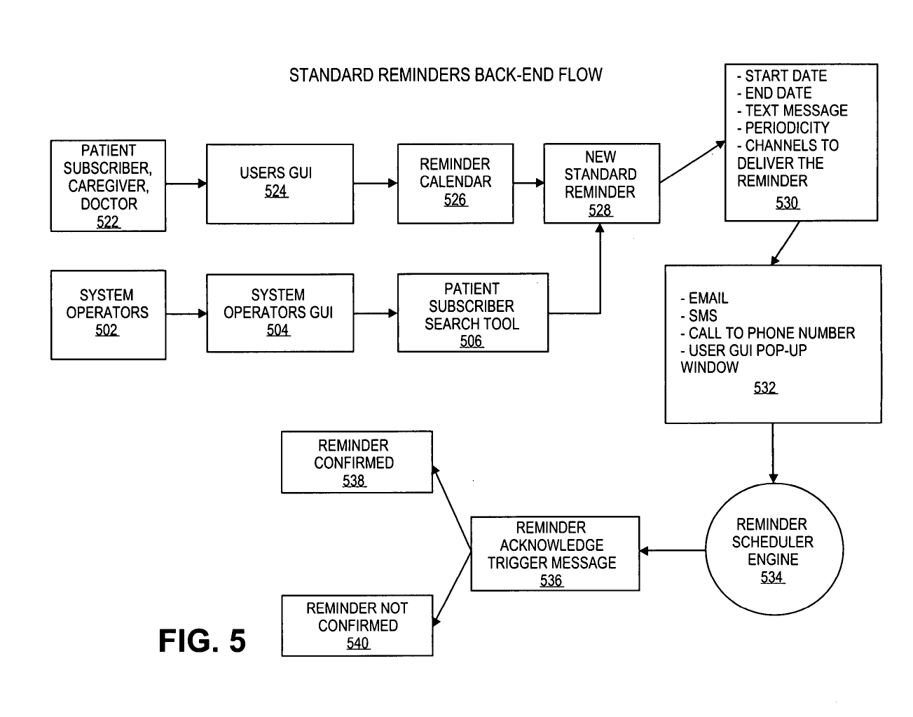

Non-Medication or Standard Reminders (illustrated in FIG. 5) are set up in the same way as that for Medication Reminders, including the ability of System Operators (502) to set up these reminders on behalf of an end user of the system. Like Medication Reminders, the subscriber can acknowledge these reminders by a specific action that entails the patient-subscriber clicking on the acknowledgement pop up window.

The Non-medication Reminders function of the system is available generally to other users of the system in addition to patient-subscribers, as part of the Reminder Calendar (522). For example, caregivers or healthcare providers have the ability to set non-medication standard reminders on a Reminder Calendar that is part of their GUI. Further, standard reminders can be programmed to have a specific periodicity (530) that can be decided upon when setting up the reminder calendar (one-time-only reminder; daily reminder or specific days reminder (for example, only on Mondays and Wednesdays) or monthly reminder or specific months reminders (for example, only in July and December).

In one embodiment, non-medication and medication reminders can be archived after approximately one hour to prevent subscribers from confusing their dosing schedules. In another embodiment, voice mail messages, are archived after 24 hours so as to prevent the accumulation of unlistened-to messages.

After reading or listening to a message from a specific healthcare provider, end-users are invited to push/touch/select a button that connects them directly with the provider or patient-subscriber who left the message. Response channels of communication can include email, wireless, Skype™, and the like, depending upon the communication channel designated in the digital file of the end user.

Track and Trigger Compliance Functions

Central to the wellbeing of patient-subscribers in the home and community setting is the monitoring and managing of patient-subscriber responses to messages, texts, questionnaires, reports or alerts sent by healthcare providers or administrators to the patient-subscriber. In one embodiment, the surveys and questionnaires have intuitive intelligence built into each question of the survey, in that certain responses by their nature may predict the future need for additional medical resources and assistance, such as the future use of the emergency room or readmission to the hospital. Responses to questions that alert the healthcare providers to possible future patient needs appear as “Actionable Alerts” in the GUI of the providers (such as illustrated at FIG. 8F) and are deemed “actionable” providing care managers the opportunity to service the patient-users needs on a preemptive basis.

Confirmation that transmissions have been received and acknowledged helps healthcare providers assess patient needs and implement care plans. In one embodiment this is done by confirming that the reminder or message has been retrieved—that is the message has been read or listened to. In another embodiment, the message can include a confirmation response which acknowledges that the action required by the reminder or message has in fact been taken by the patient-subscriber or intended party to whom the message was directed. The system, in one embodiment, monitors the timeliness of acknowledgement by the intended recipient and the action, if any, that may have been taken. In this way, compliance metrics are established for each user of the system. This allows compliance to be measured and tracked by healthcare providers overseeing care of s for the acknowledgement of medication and non medication reminders, certain health related reports and questionnaires, and other reminders/messages.

In the case of medication reminders delivered by phone, for the person responding to the call is first asked by the system to identify themselves by pressing a button. In this way, confirmation can be obtained that the medication reminder was delivered to its intended recipient.

If the person answering is not the intended recipient, the medication reminder message is not delivered. The fact of non-delivery is recorded by the system as an undelivered message, allowing remediable action to be taken by healthcare providers or administrators caring for the patient end user. Also, patient-subscribers not confirming a message or reminder, in one embodiment, can be sent an alert telling them for example that “You did not acknowledge your reminder”. Medication reminder messages that are not answered are repeated again, in one embodiment, within one hour. If no acknowledgement is received from the recipient, the medication reminder is extinguished and electronic documentation of non-compliance recorded for future action by the system managers or providers overseeing the care of the patient. For non-medication messages and other reports, failure to acknowledge these messages after 24 hours in one embodiment results in their deletion and archiving, similar to medication reminders.

For a given patient-subscriber, at the time their digital file is set up and stored in the memory of the server system (or as later updated), a track and trigger function can be set up, whereby assigned response time intervals can be programmed into and become a part of a subscriber's personal, patient specific file, and, in the event of a failure to connect an alert message can be programmed to be sent after a predetermined period. Thus, for example, after 24 hours, if an activated button/icon is not responded to, the system can be programmed to issue a notice to those healthcare providers including for example, designated caregivers of the subscriber's personal Care Network, to be notified in the event of an undelivered message or the absence of a response. More particularly, if a patient has not responded to a medication reminder, the system can be programmed to automatically issue a message, for example to the patient's treating physician, as well as to a member of the patient's family. Depending upon the nature of the particular message, the range of responses can include a call, SMS, email, etc. to the patient's nurse, attending physician, etc, or the sending of an automated call to a designated relative.

Healthcare providers who participate in the interactive communications system can define their own patient-specific criteria for issuing an alert or message, and these criteria can be made part of the patient's electronic file. Once a medication reminder is set up customized tracking triggers (442) unique to a specific patient can be established in the back-end of the interactive communications system, such that the tracking triggers can automatically be delivered to the 's healthcare providers (446) for appropriate clinical decision making (448).

Tracking Triggers

Exemplary tracking triggers related to a medication reminder can be programmed, in some embodiments to include the following:

1. Acknowledgement receipt: An acknowledgment receipt message is issued at the same time a reminder message is sent. In the case where “call into a landline or mobile line number” or email channel has been selected, in one embodiment, a second acknowledgement receipt message is sent fifty minutes after an unacknowledged first reminder message. If either the first or second trigger message (436) is successfully confirmed (438), the healthcare provider associated with the patient-subscriber, in one embodiment receives a tracking indicator showing that he has received and acknowledged the message and is thereby noted by the system to be in compliance with the reminder.

2. Not Acknowledged: A reminder that is not acknowledged in time (440) by the end user for whom it is intended, such as within an hour after its scheduled delivery time, a trigger message that the patient-subscriber has not retrieved the reminder can be sent to all designated healthcare providers in the patient's Care Network, including the patient's doctor.

In one embodiment, doctors can be provided with a software based Reminder Tracking Tool or “Tracking Dashboard” (444) that graphically records a patient-subscriber's retrieval response rate to medication and non medication reminders, reports and messages, (see for example FIG. 8 G), and in one embodiment classifying retrieval responses by color as:

GREEN: where s have retrieved and responded to more than 75% of the delivered reminders, reports, alerts or messages;

YELLOW: where patient-subscribers have retrieved and responded to between 50% and 75% of the delivered messages as above; or,

RED: where patient-subscribers have retrieved and responded to less than 50% of the delivered messages.

The Tracking Dashboard Tool is made available to healthcare providers in the form of a software program provided either in disk format, or in downloadable format via the internet.

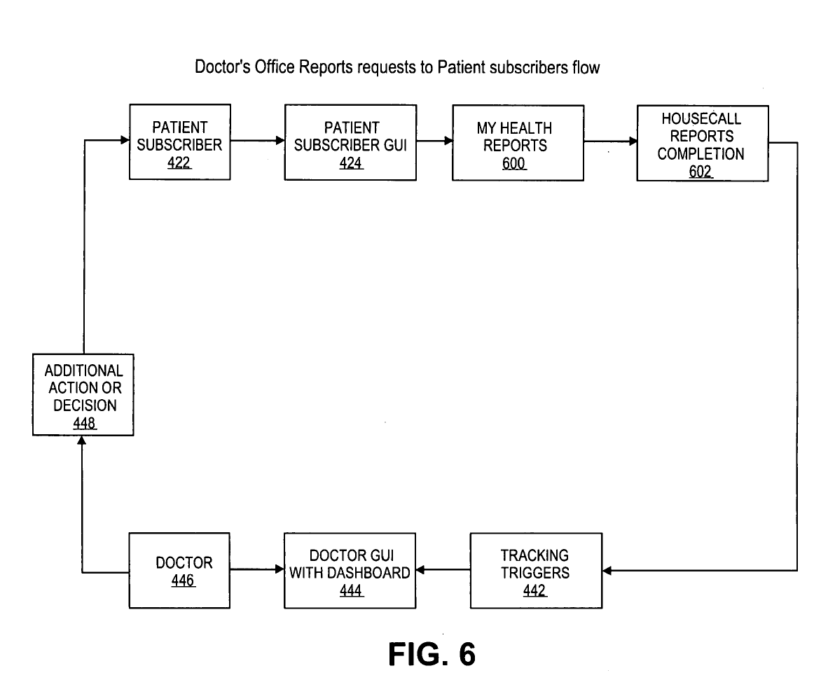

Other Tracking Triggers: Other tracking triggers available in back-end of the interactive communications system can include Report Completion triggers (FIG. 6) and Alert Reading triggers (FIG. 7)

Report Completion Triggers

Reports comprise, in one embodiment, a set of questions that healthcare providers can submit to patients, wherein the responses can be used by the provider to clinically evaluate and track a patient-subscriber's health status. Reports can be customized and tailored to a specific patient's clinical and social conditions, and can be used to decide if any specific action is needed based on patient responses. Reports Completion requests (600) can be delivered to a patient as a message alert sent to an alert message inbox that can be a voice mail inbox or electronic email inbox depending on the embodiment of the system. The patient-subscriber can directly access the report and return the completed report (602) back to the initiating healthcare provider. Healthcare providers, using the Tracking Dashboard tool of their GUI (such as might appear as illustrated in FIG. 8F), are able to monitor the response to the report including the responses to each of the questions that compiles the report as follows:

Patient-subscriber's response to a Report Sent alert: The healthcare provider can track if a patient retrieves the message (whether read or listened to or not read or listened to), and based thereon the result, make additional action decisions as appropriate (448).

Patient-subscriber's answers: Every question in a report has a closed set of answers. Questions can be customized to take into account the healthcare providers request or patient needs. Answers to the questions can be linked to specific triggers that can indicate to healthcare providers or administrators if a patient-subscriber is in need of specific care. Triggers can be characterized as follows:

RED when patient-ubscriber needs an immediate action/decision from his healthcare provider;

YELLOW when patient-subscriber needs some not-so-urgent action/decision from his healthcare provider; or,

GREEN when patient-subscriber needs no specific action/decision from his healthcare provider.

Reading Alert Triggers

Using the Tracking Dashboard tool of their GUI (444), healthcare providers can monitor a patient-subscriber's response to any Alert or message, in one embodiment categorized in one of three ways: Retrieved messages (704); Not Retrieved messages (706) and Messages Retrieved “out of time” (708)—e.g., messages read later than 24 hours from the receipt of the message or alert.

As with tracking triggers for Medication Reminders, healthcare providers are able to track patient-subscriber's responses using the Dashboard tool, and classify patient activity as either:

GREEN: when patients have retrieved more than 75% of the alerts sent by a healthcare provider;

YELLOW: when patients have retrieved between 50% and 75% of the alerts sent by a healthcare provider; or,

RED: when patients have retrieved less than 50% of the alerts sent by a healthcare provider.

With respect to FIG. 7, it is to be noted that every user, including patient-users and healthcare providers who are participants on the interactive communications service have their own Alerts Inbox (700), so that messages can circulate from the end user to each of the healthcare provider's message inboxes.

HIPAA Compliant Information Sharing

Under the Health Insurance Portability and Accountability Act of 1966 (HIPPA), privacy rules were enacted which provide federal protections for personal health information held by covered entities and extends to patients an array of rights with respect to that information. At the same time, these privacy rules are balanced so that the disclosure of personal health information needed for patient care and other important purposes is permitted. Security rules specify a series of administrative, physical, and technical safeguards for covered entities to use so as to assure the confidentiality, integrity, and availability of electronic protected health information.

Because the system of this invention is subscriber based, and only those who have registered can participate, a secured closed end (in the sense of limited membership) communications system is provided which enables the ability of the service to be HIPPA compliant. In an embodiment, also provided is the ability of the interactive communications system to securely coordinate the transmission and sharing of information related to a patient-subscriber in real time and securely among and between all healthcare providers, third party users and the patient themselves who are part of the patient's Care Network. In so doing, all parties are able to view the same information at the same time without the need for each party to query centralized data bases. In this manner, the system allows for communications to be transmitted and shared in real time among and between all layers and categories of registered users of the system who perform different functions and have different patient care responsibilities. Further, all participants in the Care Network are thus able to make more informed decisions on behalf of the patient-user based on information received and simultaneously shared by and between them.

In a further embodiment of the invention patient-users may utilize the system to define the scope of their own Care Network of provider relationships, and in so doing, are able to customize the providers, services and programs best suited to their healthcare needs.

Required for the coordinated sharing of information is that all included providers in the Care Network of the user must first be granted administrative privileges by the patient-subscriber and to do so in a HIPAA compliant manner. Furthermore, the system software allows the participating end user to add or delete healthcare providers and other users to or from the network respectively. This capability allows for the addition or deletion of healthcare providers, caregivers or family members in the patient's Care Network who are able to receive and send communications and participate in the flow of information in real time between and among themselves.

Similarly, patients can delete selective providers whom they wish to remove from the communications platform. The addition and deletion of providers is accomplished in accordance with legal and regulatory requirements governing the sharing and distribution of personal health information of a given patient-subscriber, and the system is programmed to prompt users to acknowledge such language at the time of acceptance or deletion of a given healthcare provider, caregiver or family member. For non internet users, the addition or deletion of providers can be accomplished by a system operator at the request of patient-users calling the systems operator.

In either case the system is programmed to alert the patient-user by text or voice message that a request to connect or “link” with them has been made by a healthcare provider or other party. In order to add healthcare providers to a patient's Care Network, the system is designed to allow each and every new healthcare provider or other user to apply for participation in a patient's network by obtaining legal permission to do so from the patient-user. Failure to respond to a participation request results in the patient-user receiving another automatic text or voice prompt by the system on the 4^{th} to the 7^{th} day from the date on which the participation request was made. In another embodiment, certain healthcare providers or caregivers or family members can initiate a request to the patient-user to whom they wish to connect or link in order to participate in the patient's care network.

“Build My Care Network” Feature

The secure, HIPAA compliant, network of registered users participating a the patient's care, aka Care Network, is created at the patient-users discretion using the ‘Build My Care Network’ feature of the system. The Care Network allows for the coordination of messaging and information flow between all participants of the Care Network. Implementation is enabled, in one embodiment, by an icon linking the patient-user to on-screen instructions that allow patients to compile, build, and link or add new users to their Care Network of healthcare providers (See for example FIG. 8J). Thus, providers can be added or linked to the patient's defined care network in a HIPAA compliant fashion that ensures that communication between all parties who opt-in is maintained as confidential and secure. In the process of building their network of providers or prospective users, the patient agrees to accept or reject a request by a third party provider of care (such as a doctor or caregiver) to join the patient-subscriber's HIPAA compliant healthcare network of providers. The system is programmed such that the action taken by the patient user to accept a request from a provider or prospective user to join the patient's network requires the electronic signature acceptance by the patient of the HIPAA legal disclaimer. Similarly, providers joining the network are also required to give the necessary electronic signature approval before they can be linked to the patient. The patient acknowledges acceptance by clicking on an acceptance statement contained within the application, thus granting permission to the prospective provider to share PHI (Personal Health Information) on themselves and on the patient with other providers participating in the patient's secure care network.

In addition administrators or the management service center that oversees the operation of the system are provided access to the network so that they are able to track, measure and acknowledge that a message sent by any entity in the provider-patient network has been heard or read, or by response to appropriate automated prompts, that the intended recipient has taken the required action. An exemplary screen shot of what an administrator might see in checking on user compliance is illustrated at FIG. 8E.

HIPAA Compliant Coordinated Care “Copy To” Feature

In an embodiment of the invention, the messaging function of the application grants the sender “copy to” capabilities that is the basis of the coordinated and synchronized delivery and receipt of information by users of the system. Using this feature, the patient selects the “Copy to” button which is attached to all messages sent by an end user (as illustrated in screen shot FIG. 8C). The “Copy to” button is programmed by the system to display upon the user's direction, and incorporates all the end users who are part of the patient's secure HIPAA compliant network by virtue of their acceptance and participation in the Care Network. By checking off those healthcare providers or caregivers or other users whom the patient wishes to be copied, the patient can specify who is to be copied on a message or communication. The “Copy to” function thus allows all health care providers and other users that have been successfully added to the patient-user's Care Network to receive messages and other communications.

In certain situations where the patient's response to a message sent by a healthcare provider is deemed especially important for the overall care of the patient, the system can be programmed in a customized fashion to automatically send copies of the patient's response to certain select users within the patient's defined Care Network even if the patient omits or forgets to do so. In another embodiment, the system can be programmed to identify messages in the form of questions that are sent to patients that would by their very nature demand a response. In this situation, the system can be programmed to send a message to healthcare providers within the defined Care Network, including the healthcare provider that sent the original message, alerting the sender (and others) within a specified time to the patient's failure to respond to a sent message.

“Care Giver by Proxy” Feature

The interactive communications system includes a feature that gives the a caregiver, family member, confidant or parent of a dependant minor who has been granted permission by a patient-subscriber the ability to gain access, contact and interact via the system with the patient's healthcare providers who are part of the patients Care Network. An exemplary home screen for designated caregivers is illustrated at FIG. 8K. The system can be set up such that permission is automatically granted by the patient to the caregiver by proxy upon the patient's acceptance of the caregiver into the patient's provider network. Patients, with the exception of minors, are able to cancel a caregiver proxy at any time by notifying the system operator by voice or text message of their decision. Cancelation of the proxy does not prevent patients and caregivers from sending and receiving messages to each other.

In the internet embodiment of the system, the Caregiver by Proxy obtains permission from the patient-subscriber to manage the patient's healthcare needs by acknowledging legal disclaimers that are part of the system and that allow the caregiver by proxy to act on the patient's behalf and share the patient's personal information with other participants in the patient's care network. Access to the patient's healthcare providers is obtained through an icon represented on the Caregiver by Proxy's GUI that is specifically assigned as the gateway to the patient's healthcare providers. In this manner, caregivers by proxy add to the patient's healthcare resources for needed help and can alert healthcare providers on behalf of the patient-subscriber to the patients needs in their role as first responders.

Electronic Medical Records Access

Though the interactive communications system of this invention does not act as a repository for medical records of a patient-subscriber, functionality can be provided to link subscribers any one or more Electronic Medical Records (EMR) platforms used by hospitals and physicians, to provide a portal for subscribers to the EMR to access their medical records. In addition, for physicians who are subscribers to EMR, an alternate pathway allowing access to the patient via the interactive communications system of this invention is provided.

Using appropriately programmed software activated by touching or clicking an on-screen icon (such as one as illustrated at FIG. 8L), users are automatically linked to and thus can access their own medical records resident in these electronic medical records depositories. Accordingly, the user, in a single sign on action, is given the capability of directly linking to the data repository while the user is on the interactive communications system of this invention. By going through the GUI of the invention, the need for the user to repeat steps required to authenticate themselves in the process of accessing a third party EMR repository are avoided. Moving in the opposite direction, when those doctors and other authorized care providers within a patient's Care Network are at an EMR site, they are able to get access to the communications system of this invention and communicate with the patient via this portal by activating a single sign-on icon embedded in the EMR system programmed to access the web based GUI interface of the invention.

Utilization and Metric Monitoring

A record can be generated of all patient-user actions and kept in the central server database. These metrics include pushes as well as non-pushes of buttons, full listens to recorded messages and reports, reminders, alerts and questionnaires, and “pass throughs” (occasions when the customer seeks more information or purchases a product). The record can include the time and date of each action as well as the button/icon used, and, in the case of pre-recorded messages, the action that the message asked the subscriber to perform. Further, tracking of button usage provides system operators and the healthcare providers with information on patient, end user, subscriber and customer engagement. In the same manner, by tracking button/icon use, information is provided to system operators on the loyalty to targeted marketing and sales initiatives, and provides the system operator with the ability to data-mine information regarding which ads, products, and vendors draw what kinds of user responses. Each action taken or not on the buttons is tracked in a database that is collated and reported to the sponsor partner of the system in a customized format that allows the sponsor to act in their interests. In some cases data is de-aggregated and de-identified to protect personal health information.

Surveys

The use of IVR/cloud technology provides opportunities to append brief Yes/No questions to any health related questionnaire, non health related survey, an ad-bearing button, as well as mounting longer interviews with subscribers who agree to participate in extended surveys. By aggregating database information loaded onto the system provided by system operators (e.g. insurance companies), with demographic information obtained from subscribers at registration (including clinical and medication data), the system operators, healthcare providers and other entities are able to analyze, through usage of generated metrics, subscriber use patterns. For example, the ways in which subscribers choose to use their bonus points, or the selective use of different features of the application. From this it is possible to generate attitude-opinion-behavior profiles on a statistically sound basis of value for marketing and sales. In particular, such data can serve as a revenue generator from third party entities wishing to purchase market analyses on the subscriber population. This feature relies on the fact the database is a continuously cumulative database generated by an available and ever growing customer base, and serves to support moment-in-time and over-time analysis at much lower cost than data samples purchased from other sources.

Telemonitoring

With Bluetooth, ZigBee, or RFID installed, any of the communication appliances used to communicate with the system can communicate wirelessly with in-home partner devices such as a glucose meter, blood pressure cuff, weight scale, printer, etc., Such monitoring of patient-user biological metrics supplement the messaging, reports, and reminder functions of the system, and contributes to the effective care coordination and subscriber compliance with healthcare directives. Estimates show that more than a third of the potential subscribers, over time, will have one or more in-home metering devices, and these devices can be programmed to connect to the interactive system of this invention. Further, the capability of the system provider as a Bluetooth hub, allows manufacturers of home telemonitoring devices to produce their products cheaper or have partners enter into their own branded device product line that functions along with the system. This aspect of the system acts as a pass-through of component data to data servers. The unit thus collects the patients' data readings and can provide them to healthcare providers in full compliance with HIPAA privacy regulations in addition to features such as automatic text or voice alerts when biological thresholds set by healthcare providers fall out of range based on algorithms of care programmed into the database.

Group Notifications, Teleconferencing and Social Networking

In one embodiment of the system, healthcare providers and administrators of provider/patient networks can send a group notification to all the participating members of a selected provider group such as all the doctors, or all the patients of a given doctor. Group notifications are particularly well adapted to community based initiatives such as “it is time for your flu shot” or system operator initiatives such as “please make an appointment for your annual physical examination,” or general healthcare information tips. Because certain subscribers may lack telephones with conference-calling ability or the expertise to set up conference calls on their home telephone systems, conference calling access for subscriber's customers or for their family members and friends can easily be provided by the system, as well as access to short medical presentations to groups of subscribers offered as a scheduled health educational course to those subscribers with an expressed interest in the topic. Further, the system in its wireless embodiment offers patient-subscribers and their healthcare providers the ability for visual person-to-person telehealth conferencing through Skype™ and other such technologies embedded into the system.

Wellness Messages and Health Care Information

As a part of wellness management, up to the minute information to subscribers about medical issues of particular personal interest, in some cases customized to the patient, can be provided. This can be done through a dedicated button/icon of the GUI. By selecting the button, the user can immediately be connected either to an audio, or audio/visual presentation. In one embodiment this can be a “topic of the day.” In another embodiment, it can be a prerecorded wellness message of a specific topic of interest to the user. The system can be configured at registration, or later, to allow the user to opt in to receive such messages. As a further refinement, the user can be allowed to opt in to a select set of topics made available from a general topic menu.

Incentivizing Participation

One of the features of the computer based interactive health care information delivery system of the invention is the inclusion of an incentives program designed to encourage participation through a system of rewards. In one embodiment a point system is established whereby points are earned through engagement with the system. The hoped-for result in each case is to promote the daily use of the system by patient-users and other healthcare providers as well as promote connectivity between patients and their healthcare provider network with a goal of improving the coordination of care, raising the quality of care, bettering clinical outcomes for patients and, ultimately reducing healthcare costs.

The Point System

A computer based record-keeping system is provided by the system operator which can issue rewards upon joining the system and automatically for each use thereafter:

A description of actions and associated reward points once established is made available to subscribers, either published on-line or available in print. The incentivized actions are selected to lead to the best healthcare outcomes for the patient. Further, the same type of incentivization program, modified for the specific function provided, is offered to the providers of care such as the doctors and caregivers so as to engage them in the coordination of the patient care, with the goal of improving the quality and clinical outcome of each subscriber under management through the system.

Every hour of every day, every push of every button offers a chance for a subscriber to earn points as well as be an instant winner of prizes ranging from, for example, substantial vendor coupons to goods and services spanning areas of interest to the subscriber population in the fields for example of entertainment, sports and exercise, electronics, gardening, beauty and spa items etc. Real time customization of the reward prize catalog is available to allow sponsors of the system to change, increase or substitute prizes. In all embodiments prizes and content offered by the system can be branded and customized for the sponsoring partner.

Every push of a “special of the day” button is programmed to present offers of free samples, coupons, and immediate discount purchasing of advertised products with the responsibility for fulfillment undertaken by the advertising client.

When users reach or exceed a certain number of monthly pushes on incentivized buttons over a span of a designated time period they can earn “gold member” status for the following year—for example higher value prizes, higher discounts, and access to concierge services.

These functionalities are but a tool to increase engagement of subscribers/customers. Consistent with behavioral health literature, it is understood that there are two requirements for success in helping customers actively participate in their own well-being. First, one must pay attention to peoples' needs through a trusted and familiar system such as a telephone-like device or traditional home based computer devices or electronic device currently being used by subscribers for other reasons Second, one needs to provide people with a reward/incentive mechanism that prevents fall-off of in interest, and instead stimulates use and long-term engagement with system.

Newsletters

As part of the outreach to promote system usage, the program can be augmented by publications. In one embodiment a newsletter can be published on a regular basis. Like content available on the website or via telephone recording, the newsletters can carry articles on health and wellness and other topics of general interest to its base and their caregivers in such areas as nutrition, fitness, entertainment, travel, alternative medicine, money-saving tips, and aging in place information. Other content can include inspiring stories along with puzzles and games, including advertiser-sponsored bingo games, and other advertising materials. Newsletters can among other things include: (1), broadcast schedules of social networking programs; (2), product coupons; (3), details about the incentive reward programs; and (4), announcements of contests and promotion winners.

The newsletters and website in combination are designed to add value to the services offered by the system operator by associating amusement, information, rewards, and sociability with the medical and marketing connections it provides. Future website development may incorporate community features and opportunities for subscribers to contribute content, such as stories about their experiences.

Subscribers

The users of the system, e.g. the patient-subscribers are required to register with the system in order to participate. Due to the nature of having a closed membership (i.e. closed-end user base), a secure platform can be provided for the HIPPA compliant exchange of medical information.

The registration step can handled electronically such as over the internet, or by calling a center customer service representative, or by fax or mail-in registration that is then inputted into the electronic database maintained by the system operator. In this process, the subscriber provides personal information such as name, DOB, SSN, place of birth, and so forth. Non professional subscribers are also asked to provide contact information for their primary care or general physician, physician specialist, nurse case manager, pharmacy, family member, friend, or caregiver, and the like. The information is entered into an patent-subscriber electronic file maintained in the database, the file unique to that particular subscriber. Depending upon the communication medium employed, the phone/keypad/smartphone can be set up to communicate directly to a health care provider of a patient or caregiver subscriber upon the touching of the appropriate button/icon. In another embodiment, buttons can be remotely programmed so that when pushed/touched, connection is made through the system operator which routes the call to the health care provider.

The Server System

Controlling the system network is the central server system provided and maintained by the system operator. This computer based system includes a central server system, including an I/O network, supporting system computers, supporting software for managing the functions of the system, and one or more databases stored in a server system memory. The system can be augmented by call centers which can manually input information into the system, for storage in the system database.

The central server is designed to receive information for input into its database in any one of several ways, depending upon the communications tool employed. In the case of a phone-like or keypad device, the system can employ cloud based Interactive Voice Response (IVR) technologies to both deliver messages, and intake voice responses. In the case of a smart phone, PC or tablet, the information is handled electronically, where at the central server system it can be routed to the appropriate electronically maintained patient files.

The system operator can be a specialty company maintaining its own website, supporting servers, and databases (i.e. a cloud computer server), or a technical support provider offering its services to one or more for profit companies or non-profit organizations in healthcare and related industries. Or, these same for profit and non-profit providers can operate the system themselves.

In some embodiments of the interactive communications system of this invention, the server is designed to interconnect multiple layers of subscribers who are registered participants of the system. At the bottom of the pyramid of subscribers are patients who are consumers of the application. The next layer comprises as an example, the doctors and professional caregivers managing the patients in addition to family members involved in patient care. The layer above comprises professional managers of the patients and providers, such as healthcare administrators. The layer above that comprises an executive and director level that oversees the administrators. Each of the layers of subscribers, providers, managers, administrators can be granted administrative access to the full scope of the system at each of the levels above, as well as its applications and are interconnected such that communication between any of the subscribers at any of the levels can be monitored, tracked and reviewed by parties in another layer. This functionality of the system allows for the oversight and auditing of participants on the system such that using the coordinated messaging features of the system, corrective action plans can be taken, actions can be flagged as appropriate or not, and performance of the parties can be measured, all designed to benefit the quality of care delivered to the patient user.

The computer based interactive communications system of this invention was originally designed to be used with landline telephones for seniors 65 years+ who suffer from chronic co-morbid conditions and who are not Internet users. This population, estimated at more than 17 million in 2009, faces serious problems with communication, delivery, and management of healthcare-related services. Being “unwired,” this demographic has been hard for advertisers and researchers to reach reliably and directly. The system has now been expanded through adoption of internet and smart phone technologies to include those who are wired, relevant now for all ages of the general population including those seniors able to transition to the digital age, as well as younger people with chronic conditions, or handicaps which rely on in home care options to manage health care treatments and contain costs. In fact the systems described herein can be used by anyone and everyone who are consumers of health care services.

While the present invention has been described in connection with the specific embodiments detailed above, it is to be appreciated that other and further embodiments of the invention may be devised without departing from the basic scope thereof, which scope is to be limited only by the claims.

1. A secure, closed-end, interactive communications system for the delivery of patient-centric healthcare related information, the interactive communications system comprising:
a) a central server system including an input/output network, supporting system computer or computers, supporting software and one or more databases for storing system memory;
b) a graphic user interface associated with a communications device, which device is designed to connect to said central server system using a graphic user interface including a plurality of dedicated buttons, each of which buttons is assigned a communications specific function, and can be linked to a patient-subscriber and those authorized participants designated by the patient-subscriber as participants of their a patient-subscriber's closed-end Care Network such as one or more of their family and caregivers, their selected health care providers, systems operator and related healthcare services and programs who are also part of the closed-end interactive communications system;
(c) whereby when an automatically issued reminder message from the central server system is forwarded in a secure, confidential manner to a communications device of a patient-subscriber incorporating said graphic user interface, the message can be reviewed by the patient-subscriber when received by the communications device, or not reviewed whereby the condition of reviewed or not reviewed is electronically recorded in the memory of the server system, stored as a digital text message in a patient-subscriber's digital file maintained in the database of the central server system, and a graphic user interface button linked to the sender of the message automatically visually cued to show the message responded to or not responded to.

2. The secure, closed-end, interactive communications system of claim 1 wherein the buttons are virtual buttons appearing as icons on a graphic display screen.

3. The secure, closed-end interactive communications system of claim 1 where an outgoing message can be sent with a single action, at the same time by the sender to all or select parties participating in a patient subscriber's Care Network in addition to the patient-subscriber.

4. (canceled)

5. The secure, closed-end, interactive communications system of claim 1 wherein the reminder message is a medication or non-medication reminder.

6. The secure, closed-end interactive communications system of claim 5 wherein if the medication or non-medication reminder is not reviewed, a second reminder is sent out after a predetermined interval of time.

7. The secure, closed-end, interactive communications system of claim 5 wherein the medication or non-medication reminder not being reviewed in time is stored in a data file assigned to the patient-subscriber for later retrieval by an end user and can be forwarded to the electronic inbox of a health care provider or other designated recipient.

8. A subscription based interactive communications system for managing the health care of a patient-subscriber, said system comprising:
a. a computer based central server system including one or more computers, I/O ports and a centralized database for storing patient-centric information in a number of data files specific to a particular patient-subscriber;
b. software resident in said computer based central server system for managing said patient specific data files, said data files including personal information specific to the patient-subscriber, information relating to health care providers of the patient-subscriber, and files defining a patient-subscriber's Care Network, including designation of those members of the Care Network to be copied on messages to and from the patient-subscriber;
c. said software further including a reminder scheduler engine for managing reminder communications to and from the patient-subscriber, including non-medication and medication reminders, whereby in the case of a medication reminder, a reminder to take a medication is first sent to the patient-subscriber at a specified time, and if reviewed by the patent-subscriber, a reminder reviewed acknowledgment is noted and stored in said patient-subscriber database file, if not reviewed, the condition of not reviewed is likewise stored in the patient-subscriber database file, and a second reminder message sent out, whereby within a given interval of time if the second reminder is reviewed or not reviewed, the state of reviewed or not reviewed is saved in the digital file of the patient-subscriber, wherein the reminder scheduler engine is programmed to automatically issue an alert to one or more of members of a patient's Care Network in the event of failure of the patient-subscriber to respond to a given message, either after a first or follow up reminder, said reminder notices and their responses copied to persons designated within the patient-subscriber's Care Network to be copied on said reminders

9. The subscription based interactive communications system of claim 8 wherein managing software within the system allows the patient-subscriber to set up his own medication reminders as well to have them set up by a patient-subscriber's physician, or administratively by an authorized system operator, caregiver or family member.

10. (canceled)

11. The subscription based interactive communications system of claim 8 wherein all participants of the interactive communications system are registered and authenticated members of the system, thus providing restricted access to the system, along with system security.

12. The subscription based interactive communications system of claim 9 wherein the medication reminder message is created by an end user, stored as a subfile in a patient-subscriber's digital file, the computer of the server system programmed to automatically issue a medication reminder at a time specified.

13. The subscription based interactive communication system of claim 8 wherein the system is programmed to be interoperable with other interne based data bases and health information exchanges that are not part of the communications network.

14. The subscription based interactive communications system of claim 8 wherein the patient-subscriber may, by accessing a digital Care Network file maintained within his overall patient-subscriber file at the central server system, choose to add specific persons, caregivers, healthcare providers health facilities, health programs and services, and medical management administrator to the patient's communication Care Network of health providers, or delete them from the Care Network.

15. The subscription based interactive communications system of claim 8 wherein end users participating in the communications network of a select patient-subscriber can selectively communicate with one or all of the participants in the communications network of that subscriber, the software associated with the Care Network file of a patient-subscriber automatically transmitting incoming and outgoing messages to those individuals included in the patient-subscriber's Care Network distribution list.

16. The subscription based interactive communications system of claim 8 wherein the system is designed to aggregate into a secure and confidential communications network a variety of different health care providers with different responsibilities all dedicated to sending and sharing communications related to the provision of care to the patient-subscriber with the purpose of assisting and improving the health care of the patient-subscriber.

17. The subscription based interactive communications system of claim 8 wherein the central server system notifies the end user that a healthcare or other provider or caregiver is requesting to join the patient-subscriber Care Network and thereby be granted permission to send secure transmissions with personal health information, and where the patient-subscriber accepts or rejects this request using features of the device that meet legal requirements.

18. The subscription based interactive communications system of claim 8 wherein each and every use of the graphic interface by a user of the system is electronically recorded as a metric of use that can be measured.

19. The subscription based interactive communications system of claim 8 wherein a communication requesting a response to questions or alerts sent by a healthcare provider is processed by software managing the system in such manner as to flag responses as requiring an action or not flag responses as requiring an action, and sending the flagged responses to the initiator of the communication.

20. The subscription based interactive communications system of claim 8, further including a track and trigger function whereby software resident with a communications device of a specific healthcare provider is linked to said communications system, and monitors the response or lack of response to a message or alert sent, including the timeliness of any such responses, tracking each response, and collectively tracking response rate based on the combination of all responses, wherein the collective response rate is color coded.
